(19) United States
(12) Patent Application Publication
(10) Pub. No.: US 2026/0193418 A1
(43) Pub. Date: Jul. 9, 2026

(54) GEL ELASTOMER WITH SELF-HEALING AND HIGH-STRAIN-RATE RELATED PROPERTIES

(71) Applicant: The Chinese University of Hong Kong, Shatin (CN)

(72) Inventors: Weizhao ZHANG, Shatin (CN); Jianchao ZOU, Shatin (CN); Wanrui ZHANG, Shatin (CN)

(21) Appl. No.: 19/431,703

(22) Filed: Dec. 23, 2025

Related U.S. Application Data
(60) Provisional application No. 63/742,981, filed on Jan. 8, 2025.
(60) Provisional application No. 63/831,354, filed on Jun. 27, 2025.

(51) Int. Cl. C08G 77/398; C07F 5/04; C08G 79/08; C08K 3/06; C08K 3/38; C08K 5/00; C08K 5/14; C09C 1/48; D06M 15/65

(52) U.S. Cl. CPC C08G 77/398; C07F 5/04; C08G 79/08; C08K 3/06; C08K 3/38; C08K 5/0025; C08K 5/14; C09C 1/48; D06M 15/65; C08K 2201/005

(57) ABSTRACT

Embodiments may include a silicone gel elastomer. The silicone gel elastomer may include a copolymer formed from reactions of compounds includes hydroxy silicone oil, boric acid, benzoyl peroxide, and oleic acid. Embodiments may include a method of preparing a silicone gel elastomer. The method may include reacting hydroxy silicone oil with boric acid to form a borate ester compound. The method may also include mixing the borate ester compound with benzoyl peroxide to form a cross-linked mixture. The method may further include adding oleic acid to the cross-linked mixture to form a borate-oleate copolymer. Additionally, the method may include adding a filler to the borate-oleate copolymer to form a first colloid. The method may include adding sulfur to the first colloid to form a second colloid. The method may also include heating the second colloid to form the silicone gel elastomer.

### CROSS REFERENCE TO RELATED APPLICATION

This application claims the benefit of priority to U.S. Provisional Patent Application No. 63/742,981, entitled, “GEL ELASTOMER WITH SELF-HEALING AND HIGH-STRAIN-RATE RELATED PROPERTIES,” filed Jan. 8, 2025, and to U.S. Provisional Patent Application No. 63/831,354, entitled “FIBER-REINFORCED COMPOSITE STRUCTURES CONTAINING ENERGY-ABSORBING GEL,” filed Jun. 27, 2025, the entire contents of both of which are incorporated herein by reference for all purposes.

### TECHNICAL FIELD

The present disclosure relates to the technical field of composites. In particular, the disclosure involves a self-healing shear thickening material with high-strain-rate related characteristics and its preparation method.

### BACKGROUND

As society develops, there has been a significant enhancement in material and living standards for people, but the modern environment has also grown more complex. People inevitably suffer from accidental injuries such as falls, collisions, and impacts from foreign objects in daily lives, sports, work, and taking transportation. Some high-precision instruments and aerospace structures are also subject to irresistible impacts due to the complex environment in which they are located. These impacts can destroy the structural integrity, cause serious property losses, and even casualties. Consequently, protective materials serve as critical barriers for ensuring human safety, the stable operation of equipment and instruments, and the integrity of aerospace structures, playing a vital role in impact resistance. To withstand impact or collision under various conditions, protective materials should demonstrate high impact strength and toughness across a range of impact load and strain rates, effectively dissipating impact energy and reducing or minimizing the resulting damage and injury.

The ever-increasing complexity of impact situations and scenarios has made protective materials such as steel, aluminum alloy, ceramics, foam, honeycomb structure, and bionic structure less practical, despite their past performance. In order to fully utilize their exceptional impact resistance and toughness, the next generation of high-performance protective materials should be able to enhance the overall protective performance with the composite design for advantages of different materials. As new protective materials are being developed, they are becoming increasingly intelligent and lightweight.

Among the many protective materials available, shear thickening materials have gained popularity for their many favorable qualities, such as being lightweight, highly flexible, and comfortable to wear. Particular to fluid suspensions and polymer materials is the shear thickening effect, in which the viscosity or modulus grows exponentially with the external strain rate. Responsive to external cues in a reversible manner, mechanical characteristics of shear thickening materials can adapt to complicated environmental stress fields. Currently, dense suspensions known as shear thickening fluid (STF) systems are the most used shear thickening materials. However, during preparation and application, the solvent reactivity of STF could result in molecular weight changes and precipitation. Acid-base reactivity may cause changes in the pH value of the solution. Redox reactions may result in decrease in molecular weight and properties. Photochemical reactions may cause molecular chain breakage or cross-linking. In addition, the liquid nature and sedimentation of STF can affect the thickening performance and stability.

Protective structures with flexibility and energy absorption capability, represented by those made of Kevlar fibers, glass fibers, and carbon fibers, have emerged. The high strength, low density, and flexibility of these fibrous materials are promising in the research field of protective equipment. When high-performance fibers are used as protective materials, the impact energy can be effectively dispersed through a multi-layer structural design, enhancing the impact resistance and energy absorption while improving the overall protection. However, the high energy absorption of these structures primarily results from significant irreversible deformation. As a consequence, the object or person beneath the protective structure may still experience substantial impact forces due to excessive deformation, potentially resulting in serious damage and injury.

Flexibility and impact resistance are strain rate-dependent mechanical properties of materials. Current formulations often present challenges in dissolving into polymer resins, and their infiltration can hinder the complete curing of the composites. As a result, current research on certain fiber protective structures primarily focuses on soft textiles and may not be utilized to construct rigid structural components. Therefore, forming solid structures with high impact-resistance poses significant challenges.

There exists a need for improved protective material systems. These and other needs are addressed by embodiments described herein.

### BRIEF SUMMARY

Embodiments of the present invention include a self-repairing silicone gel elastomer and methods of preparing the elastomer. The silicone gel elastomer may be a shear thickening material that thickens or stiffens when sufficient stress is applied. The shear thickening material can balance between shape stability and energy dissipation capacity, providing better thickening performance. The silicone gel elastomer exhibits significant “plastic-elastic-solid” phase transition characteristics. Moreover, the silicone gel elastomer may demonstrate wide ranges of working temperatures and frequency and phase transition. The silicone gel elastomer may possess superb mechanical strength, shear thickening, and thermal stability. In its natural state, the elastic colloid may behave like a soft viscous fluid, with typical cold-flow characteristics. Under the altering of the external loading condition, the elastic colloids can exhibit significant shear thickening caused by the local phase transformation based on the boron-oxygen (B—O) bond. The rheological properties of the colloid may be reversible even when subjected to high strain rate impact loading. The colloid may return to its initial relaxed soft-elastic state once the external force disappears.

Embodiments may include a method of preparing a silicone gel elastomer. The method may include reacting hydroxy silicone oil with boric acid to form a borate ester compound. The method may also include mixing the borate ester compound with benzoyl peroxide to form a cross-linked mixture. The method may further include adding oleic acid to the cross-linked mixture to form a borate-oleate copolymer. Additionally, the method may include adding a filler to the borate-oleate copolymer to form a first colloid. The method may include adding sulfur to the first colloid to form a second colloid. The method may also include heating the second colloid to form the silicone gel elastomer. Embodiments may include a silicone gel elastomer produced by the method.

Embodiments may include a silicone gel elastomer. The silicone gel elastomer may include a copolymer formed from reactions of compounds includes hydroxy silicone oil, boric acid, benzoyl peroxide, and oleic acid. The silicone gel elastomer may also include a filler. The silicone gel elastomer may also include sulfur.

Embodiments include a fiber-reinforced polymer composite with the silicone gel elastomer applied to the fibers. The resulting composites may have superior toughness and impact resistance while having lower densities. The composites may absorb more energy and fracture less than conventional composites. The composites may exhibit superior impact resistance, improved protection performance, and/or enhanced durability under repeated impacts.

Embodiments include a fiber-reinforced composite. The fiber-reinforced composite includes a plurality of fibers. The fiber-reinforced composite also includes a polymer matrix. The fiber-reinforced composite also includes a silicone gel elastomer. The silicone gel elastomer includes a copolymer formed from reactions of compounds including hydroxy silicone oil, boric acid, benzoyl peroxide, and oleic acid. The silicone gel elastomer includes a filler and sulfur.

Embodiments include a method of preparing a composite. The method includes mixing a silicone gel elastomer with a solvent to form a solution. The silicone gel elastomer includes a copolymer formed from reactions of compounds including hydroxy silicone oil, boric acid, benzoyl peroxide, and oleic acid. The silicone gel elastomer also includes a filler and sulfur. The method also includes applying the solution to a plurality of fibers to form a plurality of coated fibers. The method may also include contacting the plurality of coated fibers with a polymer matrix.

### BRIEF DESCRIPTION OF THE DRAWINGS

To easily identify the discussion of any particular element or act, the most significant digit or digits in a reference number refer to the figure number in which that element is first introduced.

FIG. 1 illustrates a reaction flow chart of an embodiment of the present invention.

FIG. 2 illustrates a morphological diagram of products prepared in an embodiment of the present invention.

FIG. 3 illustrates frequency sweep test results according to embodiments of the present invention.

FIG. 4A illustrates temperature dependence of the storage modulus and loss modulus of the STG measured at a frequency of 0.01 Hz according to embodiments of the present invention.

FIG. 4B illustrates temperature dependence of the storage modulus and loss modulus of the STG measured at a frequency of 1 Hz according to embodiments of the present invention.

FIG. 4C illustrates temperature dependence of the storage modulus and loss modulus of the STG measured at a frequency of 10 Hz according to embodiments of the present invention.

FIG. 4D illustrates temperature dependence of the storage modulus and loss modulus of the STG measured at the frequency of 100 Hz according to embodiments of the present invention.

FIG. 5A illustrates a self-repair curve according to embodiments of the present invention.

FIG. 5B illustrates a self-repair curve according to embodiments of the present invention.

FIG. 5C illustrates a self-repair curve according to embodiments of the present invention.

FIG. 5D illustrates a self-repair curve according to embodiments of the present invention.

FIG. 6 illustrates a method of preparing a silicone gel elastomer according to embodiments of the present invention.

FIG. 7 illustrates a graph showing density of composites and their constituents according to embodiments of the present invention.

FIG. 8 includes images showing distribution of the shear thickening gel (STG), epoxy, and fibers in the STG-applied carbon fiber reinforced polymers (SACFRPs) and distribution of epoxy and fibers in the conventional carbon fiber reinforced polymers (CFRPs) according to embodiments of the present invention.

FIG. 9A is a graph of stress-strain behavior of the CFRP and SACFRP specimens according to embodiments of the present invention.

FIG. 9B is a graph of fracture energy release/toughness of the CFRP and SACFRP according to embodiments of the present invention.

FIG. 10A shows graphs of force-displacement curves of CFRP and SACFRP laminates during the low-velocity impact (LVI) tests with different impact energy according to embodiments of the present invention.

FIG. 10B shows graphs of the force-time curves of the CFRP and SACFRP laminates during the low-velocity impact (LVI) tests with different impact energy according to embodiments of the present invention.

FIG. 11A is a graph of the comparison of the integrity loss of the reference CFRP and SACFRP laminates with various impact energy according to embodiments of the present invention.

FIG. 11B is a comparative radar plot for the specific impact strength, specific tensile strength and specific tensile modulus of the SACFRP and reference CFRP according to embodiments of the present invention.

FIG. 11C is a graph comparison of impact strength versus density for the SACFRP in this work and other advanced CFRPs and GFRPs according to embodiments of the present invention.

FIG. 12 illustrates a method of preparing a composite according to embodiments of the present invention.

### DETAILED DESCRIPTION

The advent of shear thickening gels (STGs) (also referred to as shear stiffening gels [SSGs]) address the shortcomings of shear thickening fluids (STFs). STGs are solid shear stiffening materials with a low degree of cross-linking. STG is different from a suspension system of STF by having a higher initial viscosity and by being more stable. These features make STGs easier to store and overcome the issues of particle settling and liquid volatilization. As the external loading condition changes, STGs undergo phase transition among plastic, elastic, and glassy states, which is known as the shear-stiffening effect. Without intending to be bound by theory, this transition may be caused by dynamic boron-oxygen (B—O) weak cross-linking. STGs may help fulfill a need for smart materials that combine quick response, self-healing, and stress field adaptability. STGs may demonstrate enormous potential and practical use for impact protection and cushioning structures. However, because of limitations in the rate response mechanism and material type, the stiffening response of current STGs is still relatively low, and the increase in storage modulus is typically less than 1000-fold in the normal shear frequency range of 0.1-100 Hz.

Embodiments of the present invention involve polymer composites. Embodiments relate to a preparation method and application of a borosiloxane polymer silicone gel elastomer with low cross-linking degree and high-strain-rate related properties. The raw material components of the silicone gel elastomer may include substances such as hydroxy silicone oil, boric acid, benzoyl peroxide, oleic acid, and white carbon black (silicon dioxide hydrate).

Embodiments of the preparation method may include mixing boric acid and hydroxy silicone oil in proportion for dissolution reaction. Then, benzoyl peroxide may be added to the reaction solution to promote the cross-linking reaction. The resulting polymer may be dehydrated to prepare a solid polymer matrix. Afterwards, oleic acid may be added into the polymer matrix for plasticization reaction. White carbon black powder may be slowly added for dispersion. Once the reaction is completed, an appropriate amount of sulfur and vulcanization accelerator may be added to the polymer matrix for sulfation reaction. Finally, the mixtures may be left to cool to room temperature, and the corresponding elastomer can be obtained.

By adjusting the varieties and contents of each component in the raw materials, the silicone gel elastomer prepared by the present invention may exhibit significant “plastic-elastic-solid” phase transition characteristics. The silicone gel elastomer may demonstrate improved properties, including wide ranges of working temperature and frequency and phase transition, improved mechanical strength, increased shear thickening, and increased thermal stability. Under an external loading condition, the elastic colloids can exhibit significant shear thickening related to local phase transformation with the boron-oxygen (B—O) bond. The colloid may be self-healing such that the colloid will return to its initial relaxed soft-elastic state once an external force disappears.

The less-than-ideal material properties and other shortcomings of current offerings may be addressed by the self-repairing shear thickening materials and preparation methods described herein. The shear thickening material can achieve a balance between shape stability and energy dissipation capacity, as well as provide better thickening performance. The benefits of the embodiments are described herein.

As an example, embodiments of the present invention may involve a condensation reaction between hydroxy silicone oil and boric acid to produce borate ester compounds. Benzoyl peroxide may be added to the reaction to create the borate ester with peroxide bonds, enhancing thermal stability, solvent resistance, and antioxidant properties of the compound. The cross-linking reaction of the borate compound may be further promoted. This may enhance mechanical strength and confer reversibility and self-repairing ability to the compounds. Oleic acid may then be utilized to carry out free radical addition reaction and introduce oleate groups for a condensation reaction to generate a borate-oleate copolymer. The copolymer may possess both borate ester and oleate groups and may have dual functionality from having both these groups.

Borate esters can enhance thermal stability and facilitate the formation of protective films on surfaces, especially in high-temperature environments. Additionally, the borate ester groups can provide chemical resistance and enhance anti-wear characteristics in mechanical systems. Oleate groups, derived from fatty acids, may impart excellent lubrication properties, improving flow and reducing friction. Their long alkyl chains can enhance compatibility with organic phases or surfaces, reducing surface energy and improving spreadability. Moreover, oleate groups can provide a protective barrier against oxidation or corrosion. The copolymer, by having both borate ester and oleate groups, can offer multifunctionality and simultaneously combine the high thermal stability and anti-wear characteristics of borate esters with the lubricity and corrosion resistance of oleate groups.

The borate ester and oleate groups may be reversible dynamic bonds that can fracture and reorganize to consume energy when subjected to external energy impacts, further enhancing their energy dissipation capabilities. White carbon black, a rigid inorganic filler, may be incorporated into the copolymer matrix to create a three-dimensional network structure, which may hinder the flow of copolymer molecules when subjected to shear force, leading to a notable shear thickening effect. As a result, the rigidity and heat resistance of copolymer may be enhanced.

The preparation process of the shear-thickening gel in the present invention is simple to operate and has good process stability. The components are commercially obtainable and are fairly limited. The operations involve mostly mixing and heating. The process can be scaled and industrialized.

The shear-thickening gel in the present invention may possess good shape stability and may still maintain significant strain sensitivity and response. Moreover, the shear-thickening gel can work effectively under wide ranges of temperature and frequency and phase transition. The shear-thickening gel may have improved mechanical strength, shear thickening, and thermal stability.

The shear thickening gel can quickly self-repair. The rheological properties of the colloid are reversible. The colloid may revert to its initial relaxed soft-elastic state once the external force disappears, even under impact loading with high strain rate.

The shear-thickening gel may have a low density and may be lightweight. The low weight makes the shear-thickening gel advantageous for applications where a human has to bear the weight or applications where weight is a factor (e.g., protecting payloads in transit). The shear-thickening gel may be widely used in different scenarios and complex stress environments.

The shear thickening gel may exhibit excellent energy dissipation capacity. The energy dissipation effect may be significantly improved compared with a traditional shear thickening gel.

The STG may be applied to carbon fiber reinforced polymers (CFRP) by an impregnation process. Multiple layers of carbon fabric may be infused with STG and an epoxy resin, followed by compression molding to fabricate the final composite structure. The obtained STG-applied CFRP (SACFRP) may exhibit significantly enhanced toughness compared to conventional CFRPs. The toughness may be the result of viscous energy dissipation and phase-transition energy absorption enabled by the STG under high-rate deformation during impact events. In addition, the flowable STG may facilitate spatial redistribution of impact energy across the SACFRP composite structures, increasing the effective load-bearing area and reducing the localized stress and strain concentration. Experimental observation and theoretical modeling further demonstrate that the SACFRP composites can unload the impact object through elastic bending, reducing the appearance of permanent deformation. The results of low-velocity impact (LVI) tests indicate that the introduction of STG can significantly improve the specific impact strength of a composite. Compared with the unmodified multi-layer CFRP structure, the SACFRP structure prepared by the present invention exhibited improved impact protection effect, highlighting their potential for widespread application in protective equipment and impact-resistant structural components across various industries.

In the SACFRP composite structures, the incorporation of STG with phase-transition and energy-absorbing capabilities improves the fibers-epoxy adhesion, and lead to a protective layer with strain rate-dependent characteristics on the fiber surface, making the number of molecules covalently bonded at the fiber-STG interphase far greater than that at the conventional fiber-epoxy interphase. Moreover, the STG still maintains the gel state and exhibits shear thickening performance within the cured composite structures under the dynamic impact, allowing the fibers/fabrics to absorb more energy to achieve better impact resistance. In addition, the mass fraction of STG to epoxy in the SACFRP may be controlled so that the shear thickening effect of the STG and viscous loss of the SACFRP structures to impact are not excessively weakened, while structural rigidity of the composites can be maintained. Compared to the CFRP without STG impregnation, the toughness of the SACFRP in contact with the impact object is significantly improved, extending the contact and interaction time of the SACFRP structures with the impact object, enabling the SACFRP to absorb more kinetic energy of the impactor and convert it into structural deformation and internal energy through torsion and bending, thereby improving the impact resistance of the composite structures.

The introduction of STG in the SACFRP may reduce brittleness and may alter the LVI resistance mechanism of the composite. The viscoelastic deformation and flowing out of the STG, as well as the associated load transfer, can enlarge the impact area of the SACFRP structures from the loading position, effectively distributing the impact energy under LVI. Additionally, the shear thickening behavior of STG under high strain rate induces phase change, further enhancing energy dissipation and reducing impact localization.

Embodiments include preparation methods for fiber-reinforced composite structures containing the phase-transition and energy-absorbing gel for high toughness and impact resistance. The produced SACFRP structures with superior impact resistance can be widely used across various industrial fields.

### Example 1

An example method for preparing a shear thickening gel elastomer with self-healing, high-thickening, and low-density is described.
1. First, boric acid and hydroxy silicone oil are placed in a kneader container. A dissolution reaction proceeds for 1-2 hours under the pressure of 13-14 kPa and temperature of 70-80° C.
2. Benzoyl peroxide is added to the reaction solution with thorough stirring for 0.5 h to promote a cross-linking reaction. The temperature is adjusted to 150-180° C. The mixture is stirred every 20 minutes for more than 2 h, for the polymerization dehydration reaction to proceed. The mixture is formulated into a solid polymer matrix.
3. Oleic acid is added into the polymer matrix. The resulting mixture is stirred for 15-30 minutes for a plasticizing reaction to proceed.
4. White carbon black is added. The mixture is stirred for 1-2 hours to completely disperse the white carbon black.
5. After the reaction is completed, the mixture is cooled to ambient temperature. The initial elastic colloid is obtained.
6. A sufficient amount of sulfur and vulcanization accelerator are added to the colloid. A vulcanization reaction is carried out by stirring at 80-100° C. for 2-4 hours.
7. After the reaction is completed, the mixture is cooled to ambient temperature. The vulcanized elastomer is obtained.

In step a), boric acid can undergo reversible coordination cross-linking reaction with the polymer-containing hydroxyl groups to form the three-dimensional network structure, thereby improving the viscoelasticity and shear thickening effect of the colloid.

In step b), benzoyl peroxide acts as the free radical initiator. which will undergo decomposition reaction during the stirring process to produce free radicals, promote cross-linking condensation of the hydroxy silicone oil, enhance the cross-linked network structure inside the colloid, and thus improve the shear thickening performance of the gel. Moreover, the cross-linking effect can increase the interaction force between molecules or particles in the colloid, thereby improving the stability and responsiveness of the colloid under high shear rates. In addition, benzoyl peroxide, with excellent interfacial activity under sufficient conditions, can be used as a dispersing aid to promote improved dispersion of solid particles or polymer chains in the colloid. A more uniform dispersion state is conducive to improving the overall viscoelastic properties of the colloid, thereby enhancing its shear thickening properties.

In step b), benzoyl peroxide and boric acid can act synergistically to form a reversible and covalent cross-linking network, which can significantly enhance the mechanical properties, rheological properties, and long-term stability of the shear thickening gel.

In step c), the polar groups of oleic acid can interact with polar groups (such as hydroxyl groups) in the colloid through hydrogen bonds, forming the three-dimensional barrier to hinder the sliding of the molecular chain. The viscosity and shear thickening effect of the colloid are then improved. In addition, the hydrophobic, long-chain fatty groups of oleic acid may interact with other organic components in the colloid, thereby enhancing the network structure of the entire system. The mechanical strength and elastic properties of the final shear thickening gel may then be improved.

In step d), white carbon black is nano-scale silica particles that can form a relatively dense three-dimensional network structure under shear. The shear resistance and anti-shear viscosity reduction properties of the colloid may be enhanced. As an inorganic rigid filler, white carbon black may improve the mechanical properties, such as hardness and compressive strength, of the colloid. The addition of white carbon black may also comprehensively improve the optical properties, electrical properties, thermal properties, and stability of the colloid.

In step d), the oleic acid, possessing both polar and hydrophobic groups, can be adsorbed on the surface of filler particles. This adsorption may improve the dispersibility of fillers in the matrix and inhibit the agglomeration and precipitation of particles. As a result, the stability of the entire colloid system may be improved. Some amount of free oleic acid and boric acid will remain in the system, which may adsorb onto the filler particles because of the polar and hydrophobic groups. The polar or hydrophobic groups within the copolymer itself can interact with the filler particles. The borate ester and oleate functional groups of the copolymer may be responsible for adsorption and improved dispersion.

In step d), boric acid may be adsorbed on the surface of the filler. The adsorption may enhance the bonding between the filler and the matrix and improve dispersion stability. The rheological properties and storage stability of the colloid may be improved. In addition, boric acid can be used as the buffer to adjust the pH value of the system to the optimal range, thereby optimizing the dispersion and network structure of the filler.

In step f), sulfur and vulcanization accelerators may be introduced to chemically cross-link polymer chains, enhancing the mechanical properties, durability, elasticity, and/or thermal stability of the material. Sulfur is associated with vulcanization processes in STG systems, where it may create crosslinks between polymer chains. In addition, stirring at 80-100° C. can activate the vulcanization accelerators, accelerating the initiation of the cross-linking process while reducing energy consumption and improving overall efficiency.

The elastomer may be the result of the reactions, crosslinking, and other interactions of the materials described herein. The elastomer may be a copolymer, a filler (e.g., white carbon black), sulfur, and a vulcanization accelerator.

### Example 2

An example method for producing a shear thickening gel is described.

### Step (1): Preparation of Borate Ester Compounds

First, the hydroxy silicone oil with a mass fraction of 74% (relative to all components used to produce the silicone gel elastomer) and the boric acid with a mass fraction of 6% are sequentially placed in a kneader container. Then, the pressure of the kneader container is adjusted to 13 kPa, and the temperature is set to 70° C. The stirring in the kneader container is started. The stirring is continued for 2 hours to ensure thorough and uniform mixing of the two components.

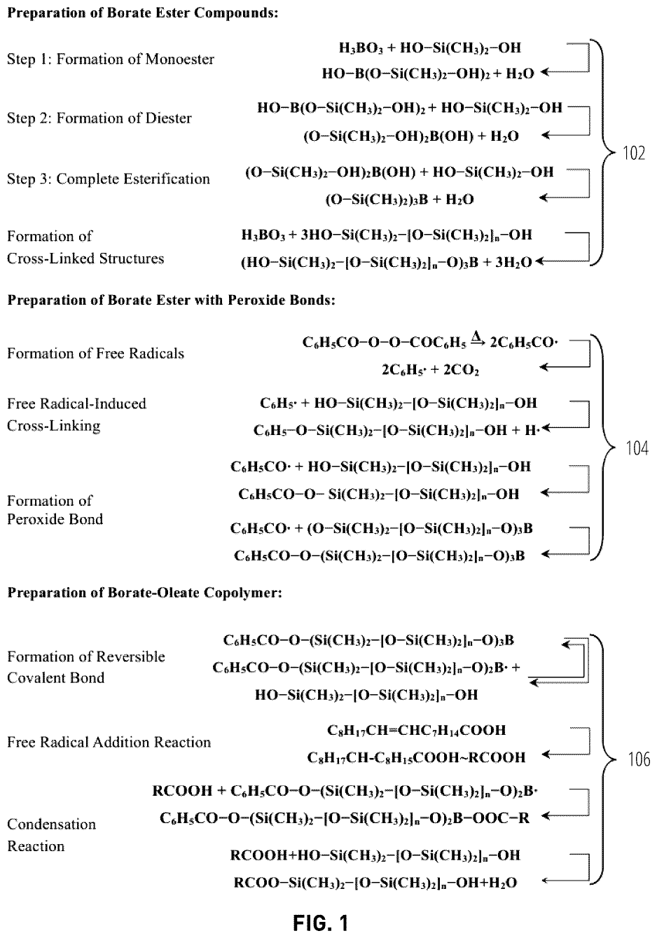

In this process, borate ester compounds, with a three-dimensional network structure, are generated in a reversible coordination cross-linking reaction between hydroxy silicone oil and boric acid, as in the equation in stage 102 in FIG. 1. The cross-linking reaction improves the viscoelasticity and shear thickening effect of the colloid.

The equations in FIG. 1 are provided for illustrative purposes. Some compound formulas may be simplified to show the main functional groups. As with most chemical reaction systems, there may be additional reactions that occur that are not illustrated in FIG. 1.

In addition, the reactions in FIG. 1 may not proceed to completion.

Step (2): Preparation of Borate Ester with Peroxide Bonds

After the completion of step (1), benzoyl peroxide, at a mass fraction of 0.5%, is added to the mixed solution of borate ester compounds generated in the kneader container. The benzoyl peroxide and the mixed solution are stirred thoroughly for 0.5 h to promote further cross-linking reaction. Subsequently, the temperature is adjusted to 150° C. and stirred every 20 minutes until the mixed solution is completely transformed into a solid polymer matrix with a large amount of silky luster.

The above reaction process includes multiple cross-linking effects. First, the free radicals generated by the decomposition of benzoyl peroxide undergo cross-linking condensation with hydroxy silicone oil to form the borate ester with peroxide bonds, as in the equation in stage 104 in FIG. 1. Second, benzoyl peroxide and boric acid play a synergistic role to form the reversible and covalent cross-linking network. This cross-linking can significantly enhance the mechanical properties, rheological properties, and long-term stability of the shear thickening gel. In addition, benzoyl peroxide can promote better dispersion of solid particles or polymer chains in the colloid, which is conducive to improving the overall viscoelastic properties of the colloid, thereby enhancing its shear thickening properties.

### Step (3): Preparation of Borate-Oleate Copolymer

To achieve the plasticizing reaction, oleic acid, with a mass fraction of 1.5%, is added to the solid borate ester with peroxide bonds matrix generated in step (2). A relatively stable polymer matrix may be obtained by sufficiently stirring and mixing for 30 minutes.

In this process, oleic acid undergoes a free radical addition reaction to generate oleate groups. The oleate groups undergo a condensation reaction with borate ester with peroxide bonds to generate borate ester-oleate copolymers possessing both borate ester and oleate groups and serving dual functionality, as in the equation in stage 106 of FIG. 1. In the reaction process, the hydrophobic, long-chain fatty groups of oleic acid can interact with other organic components in the colloid, enhancing the network structure of the entire system. Hence, the mechanical strength and elastic properties of the final shear thickening gel may be improved.

### Step (4): Preparation of Initial Elastic Colloid

White carbon black with an average particle size of 50-800 nm at a mass fraction of 16% is slowly added to the mixture of borate-oleate copolymer obtained according to step (3). High-speed stirring is performed for 2 hours until the white carbon black is completely wet and dispersed. After the reaction is completed, the initial elastic colloid may be obtained by leaving the mixtures to cool to ambient temperature.

In this process, oleic acid and boric acid may be adsorbed on the surface of the white carbon black. This adsorption may enhance the bonding between the filler and matrix, improve dispersibility, and inhibit agglomeration and precipitation of particles, and improve the rheological properties and storage stability of the colloid. In addition, white carbon black may form a relatively dense three-dimensional network structure under shear, which can significantly enhance the shear resistance, anti-shear viscosity reduction properties, hardness, and compressive strength of the colloid.

### Step (5): Preparation of Vulcanized Elastomer

After the completion of step (4), the initial colloid is transferred from the kneader container to another reactor for the vulcanization reaction with sulfur at the mass fraction of 1.5% and vulcanization accelerator (e.g., diphenyl guanine, dibutyltin dilaurate, triethanolamine, thioglycolic acid, and dicyclohexylamine) at a mass fraction of 0.5%.

The benzene ring in diphenyl guanine may engage in free radical reactions, contributing to the formation of a more stable cross-linked network. In the presence of peroxides (e.g., benzoyl peroxide), the guanine structure can be activated to facilitate cross-linking between borate or siloxane chain segments. The amino (—NH₂) and keto (C═O) groups in guanine can participate in dynamic covalent bonding reactions with borate ester groups (B—O), improving the dynamic properties of the cross-linked network. The hydrophobicity of the aromatic ring in diphenyl guanine may allow diphenyl guanine to interact with organic components (e.g., oleic acid groups) in the shear thickening gel, further enhancing the mechanical properties and uniformity of the material's network. Other accelerators may behave in a similar fashion.

The mixture is stirred at 100° C. for 2 h. Once the vulcanization reaction is complete, the mixtures are cooled down to ambient temperature, resulting in the vulcanized elastomer.

In the vulcanization process, the degree of entanglement between molecules is increased. The increased entanglement may improve the heat resistance and thermal stability among molecular chains and reduce the swelling degree of the shear thickening gel in organic solvents. Consequently, following vulcanization treatment, the mechanical strength, shear resistance, and thermal stability of the shear thickening gel may be improved.

### Example 3

### Morphological Testing

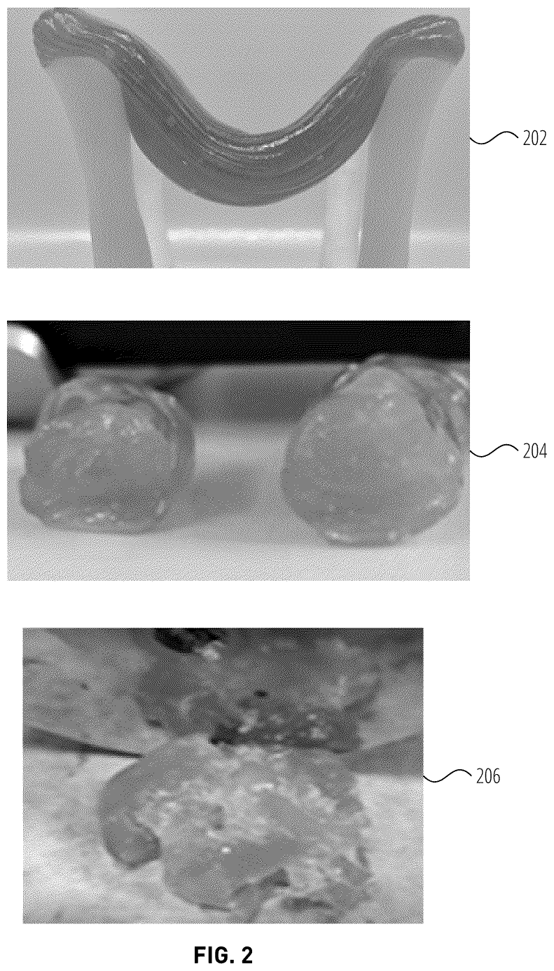

The STGs prepared in the examples were tested for morphology and state under different conditions, as shown in FIG. 2.

Under natural conditions, the STGs prepared in the examples possess good stability and can maintain a stable shape for a long time. Photo 202 illustrates the stability and resistance to cold flow of the shear thickening gel at rest. In its natural state, the STG maintains a relatively stable shape over time, reducing or effectively minimizing the cold flow phenomenon.

The STGs prepared in the examples exhibit elasticity under rapid pulling, leading to ease of breaking with flat fracture surfaces, as shown in photo 204. The rapid pulling was at a velocity of 30 m/s, using a square-shaped drop hammer in the experimental setup.

The failure morphology of STGs is in the form of fragmentation under rapid impact, as shown in photo 206 exhibiting solid state performance. Under rapid impact conditions, STGs may exhibit a failure morphology characterized by fragmentation. When subjected to a sudden and high-rate force, STG rapidly transitions from a viscous state to a rigid, solid-like state due to its shear-thickening properties. This behavior may arise from the formation of temporary, densely packed particle networks within the gel matrix, which can resist deformation up to a critical threshold. Experimental observations of such impacts often reveal smooth, flat fracture surfaces in individual fragments, indicative of the material's transition to a more rigid state just before failure. This behavior underscores the unique multi-phase nature of STGs and their capability to absorb high-impact energy before fracturing.

The above results indicate that STGs can provide shear thickening effect by phase transition among the plastic (202), elastic (204), and glassy (206) states with the altering of external loading condition.

In a plastic state, the STG exhibits a viscous flow or deformation, allowing it to absorb energy and adapt to gradual stress without breaking. This property is advantageous for applications requiring damping and energy dissipation.

In an elastic state, the STG deforms reversibly under stress, akin to an elastomer. The STG provides resilience and toughness, enabling recovery after deformation, which is crucial for repetitive or moderate-stress conditions.

In a glassy state, the material behaves rigidly and is prone to brittle fracture under high or rapid stress. This state offers structural integrity and resistance during sudden impacts or extreme loading scenarios.

The shear-thickening behavior of STGs may depend on the dynamically reversible process of fracture and formation of the boron-oxygen (B—O) crosslink. The breaking of the B—O bonds may be faster than the formation at low strain rate, while there may be no time for the fracture of the B—O crosslink at high rate. The remarkable energy absorption of STG is commonly acknowledged to be attributed to its substantial elevation in viscosity or modulus with the increasing of strain rate.

### Properties Testing

STGs were pressed into a circular sheet with thickness of 1 mm and diameter of 25 mm and then placed on the rheometer carrier platform. Simultaneously, circular frequency scanning and temperature variation ranges were set, and the testing mode were adjusted by applying steady state, transient, and dynamic stress-strain loads through the circular loading tip.

A circular frequency (often denoted as ω) is a parameter commonly used in oscillatory rheological testing. It is related to the frequency of oscillation and is measured in radians per second (rad/s). In rheology, circular frequency represents the angular speed of oscillatory deformation applied to the sample during dynamic mechanical analysis. It is mathematically defined as:

$$ω = 2 π f$$

where ω=circular frequency (rad/s) and f=frequency of oscillation (Hz, cycles per second).

During rheological testing, the circular frequency helps evaluate the material's viscoelastic properties across a range of deformation speeds. By varying ω, one can measure how the material's modulus (storage and loss module) and damping properties change with the rate of deformation. This is important for materials like STGs, as their mechanical properties can depend significantly on the rate of applied stress or strain.

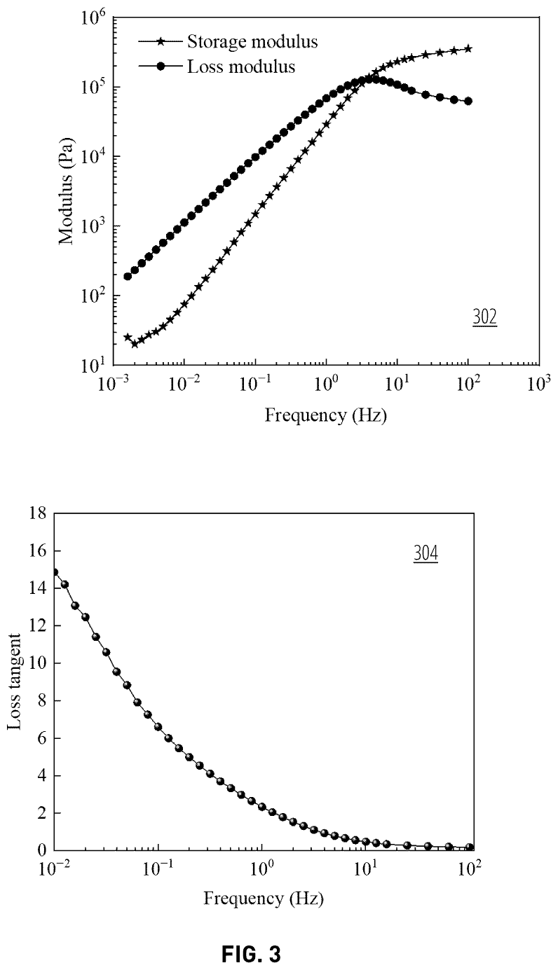

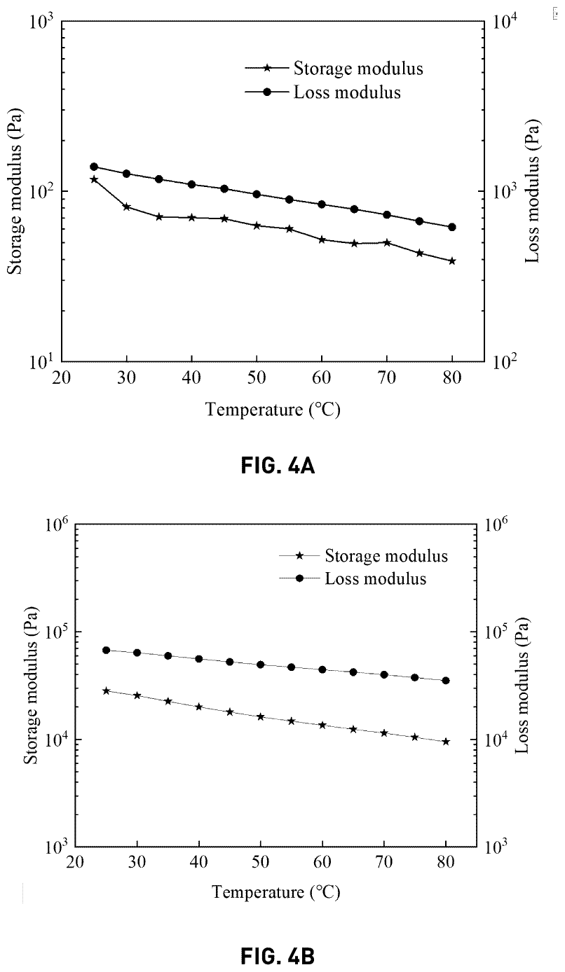

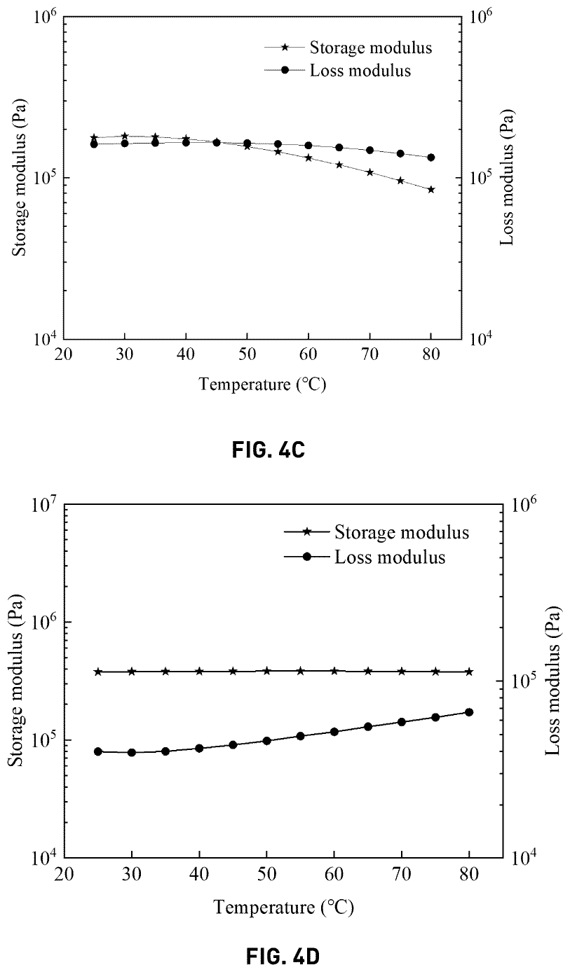

The STGs were subjected to shear or tensile stress during the flow process, resulting in deformation. Rheological properties of the STGs were derived by measuring the rheological data including the shear rate, stress, oscillation frequency, and stress-strain amplitude under different loading conditions, and calculating the rheological parameters involving viscosity, energy storage modulus, loss modulus and loss tangent, as illustrated in FIG. 3 and FIG. 4A to FIG. 4D.

Graph 302 demonstrates that the storage modulus of the STG is significantly lower than its loss modulus at the lower shear frequency level, indicating that the STG is in a viscous fluid state. As the shear frequency exceeds the threshold value, the storage modulus begins to be greater than loss modulus, indicating solid-phase transformation of the STG. Moreover, as the external shear frequency gradually rises from 0.001 to 100 Hz, the storage modulus of the STG increases by more than 4 orders of magnitude.

Graph 304 shows the loss tangent. The loss tangent is the ratio of loss modulus to storage modulus and can be used to assess the material state of the STG. The STG maintains the viscous fluid state, which is indicated by the loss tangent value of over 1, under the shear frequency lower than 25.12 rad/s. As the shear frequency exceeds the threshold value, the storage modulus of STG exceeds its loss modulus, resulting in the transition to the solid state. A loss tangent greater than 1 indicates a liquid state. A loss tangent less than 1 indicates a solid state. Graph 304 indicates a transition (at 25.12 rad/s) from a liquid state at lower frequencies to a solid state at higher frequencies.

Compared with typical STGs, the STG prepared in present invention exhibited wider phase-transition and better shear thickening performance.

FIG. 4A to FIG. 4D demonstrate the performance stability of STG at different temperatures. FIG. 4A shows a graph of storage modulus and loss modulus at a frequency of 0.01 Hz.

FIG. 4B shows a graph of storage modulus and loss modulus at a frequency of 1 Hz.

FIG. 4C shows a graph of storage modulus and loss modulus at a frequency of 10 Hz.

FIG. 4D shows a graph of storage modulus and loss modulus at a frequency of 100 Hz.

At lower frequencies, as the temperature increases, the storage and loss moduli of STG both decrease slightly, falling less than 1 order of magnitude. As the frequency increases, the decrease in the storage and loss moduli gradually slows down. When the frequency reaches 100 Hz, the storage and loss moduli of STG are basically constant at different temperatures. The above results indicate that the performance of the STG prepared in the present invention is stable at different temperatures. The STGs can be used in applications at a range of temperatures.

### Self-Repair Testing

STGs were pressed into circular sheet with thickness of 1 mm and diameter of 25 mm and then placed on the rheometer carrier platform. Simultaneously, circular frequency scanning with 0.001-100 Hz and temperature with 25° C. were set. After the test was completed, the STG specimen was left at ambient temperature for self-healing with 4 minutes, and then a second test was conducted under the same conditions. A third test was performed after another 4 minutes. A fourth test was performed after another 4 minutes. In turn, a total of four high-frequency shear tests were conducted. The changes in the storage modulus, loss modulus, complex modulus, and complex viscosity curves obtained from the four tests were compared.

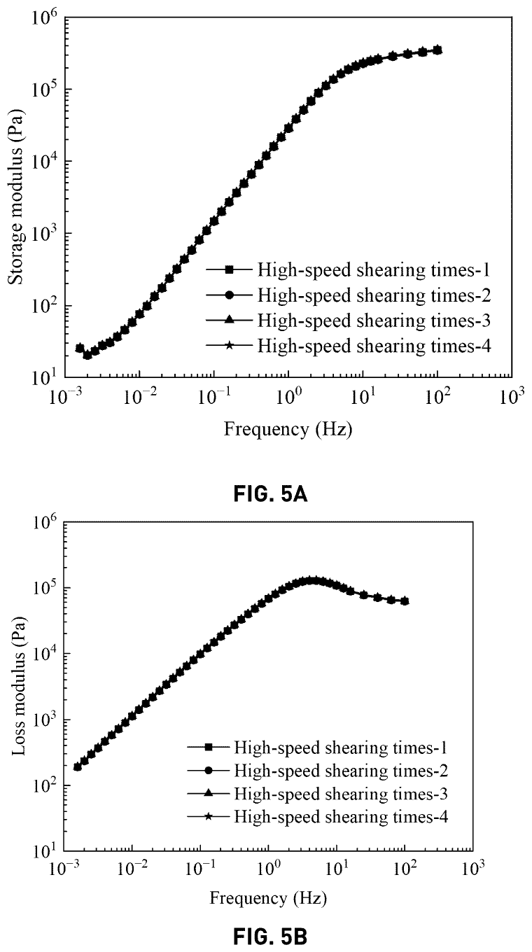

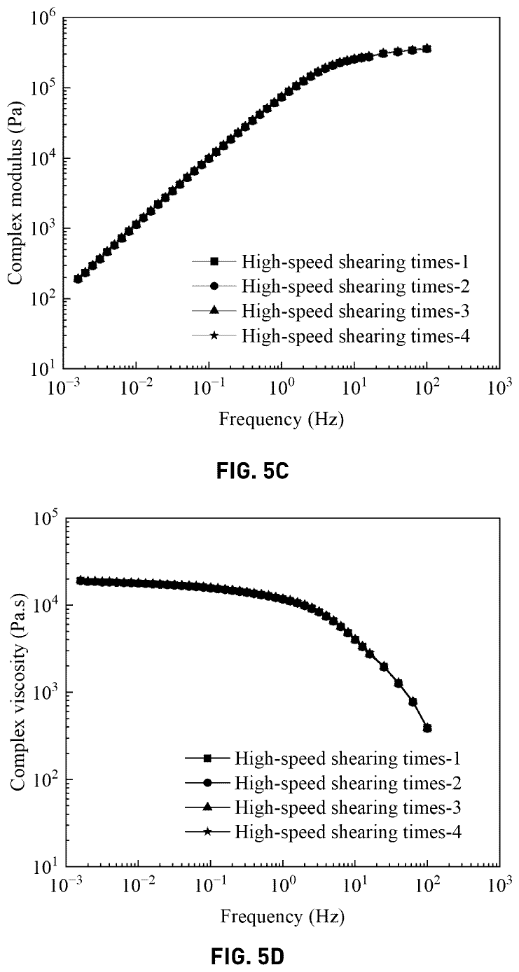

FIG. 5A shows the storage modulus at different frequencies for the four high-frequency sheer tests. The graph shows that the four curves are nearly identical.

FIG. 5B shows the loss modulus at different frequencies for the four high-frequency sheer tests. The graph shows that the four curves are nearly identical.

FIG. 5C shows the complex modulus at different frequencies for the four high-frequency sheer tests. The graph shows that the four curves are nearly identical.

FIG. 5D shows the complex viscosity at different frequencies for the four high-frequency sheer tests. The graph shows that the four curves are nearly identical.

FIG. 5A to FIG. 5D illustrate the self-repair data of the STGs prepared by the present invention under multiple repetitive loads, clearly demonstrating that the STGs are well equipped with the ability of rapid self-repair. These curves are almost consistent with the curve of the original specimen within only 4 minutes of self-repair.

### Example Methods

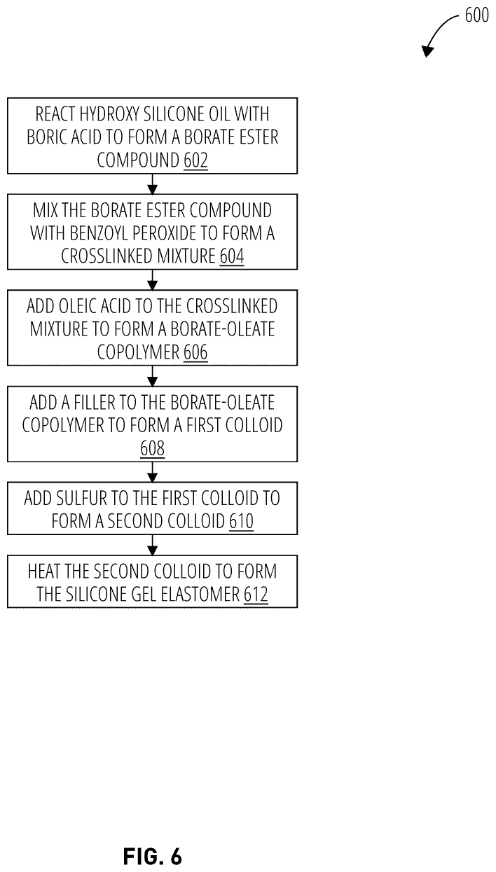

Embodiments of the present invention may include preparing a silicone gel elastomer, which may be any silicone gel elastomer described herein. FIG. 6 shows a method of preparing the silicone gel elastomer.

In block 602, method 600 reacts hydroxy silicone oil with boric acid to form a borate ester compound. Reacting the hydroxy silicone with the boric acid may include placing the hydroxy silicone oil with the boric acid in a kneader container for a duration in a range from 1 hour to 2 hours. A kneader container may include a screw, a blade, or other suitable equipment to mix or knead components. Reacting may be at a pressure in a range from 5 to 10 kPa, 10 to 13 kPa, 13 to 14 kPa, 14 to 16 kPa, or over 16 kPa. Reacting may be at a temperature in a range from 50 to 70° C., 70 to 80° C., 80 to 90° C., 90 to 100° C., or over 100° C. The reaction may include the condensation reaction in stage 102 and/or the preparation described in step (1) of Example 2.

In block 604, method 600 mixes the borate ester compound with benzoyl peroxide to form a cross-linked mixture. The mixing of the borate ester compounds and the benzoyl peroxide may occur over at least 2 hours. The mixing may occur in a range from 1 hour to 2 hours, 2 to 3 hours, 3 to 4 hours, 4 to 5 hours, or over 5 hours. The borate ester compound and the benzoyl peroxide may not be actively mixed over the entire duration. For example, active stirring may be every 10 to 20 minutes, 20 to 30 minutes, 30 to 40 minutes, or 40 to 60 minutes. Active stirring may be for a duration of 5 to 10 minutes, 10 to 20 minutes, or 20 to 30 minutes. Mixing the borate ester compounds with the benzoyl peroxide compound may be at a temperature in a range from 100 to 150° C., 150 to 180° C., or 180 to 200° C. Block 604 may include the reactions in stage 104 and/or the preparation described in step (2) of Example 2.

In block 606, method 600 adds oleic acid to the cross-linked mixture to form a borate-oleate copolymer. Adding the oleic acid to the cross-linked mixture may occur at least 2 hours after mixing the borate ester compound with the benzoyl peroxide. The oleic acid and the cross-linked mixture may be stirred for 5 to 10 minutes, 10 to 20 minutes, 20 to 30 minutes, 30 to 40 minutes, or 40 to 60 minutes. Block 606 may include the reactions in stage 106 and/or the preparation described with step (3) of Example 2.

In block 608, method 600 adds a filler to the borate-oleate copolymer to form a first colloid. The filler may be any filler described herein. Oleic acid and/or boric acid may adsorb onto the surface of the filler. The filler may be mixed with the borate-oleate copolymer for a duration in a range from 30 minutes to 1 hour, 1 hour to 2 hours, 2 hours to 3 hours, or over 3 hours. The first colloid may be cooled to a temperature of 20° C. (e.g., room temperature). Cooling may be by turning off heat and waiting for room temperature. Cooling may include convective cooling or refrigeration. Block 608 may include the preparation described in step (4) of Example 2.

In block 610, method 600 adds sulfur to the first colloid to form a second colloid. A vulcanization accelerator may also be added to the first colloid.

In block 612, method 600 heats the second colloid to form the silicone gel elastomer. The second colloid may be mixed by stirring for 0.5 to 1 hour, 1 hour to 2 hours, 2 to 3 hours, or over 3 hours. A vulcanization reaction may occur. The reaction may occur at a temperature in a range from 90 to 100° C., 100 to 120° C., 120 to 140° C., or over 140° C. Block 612 may include the preparation in step (5) of Example 2. The stirring in the kneader container may be turned off. The silicone gel elastomer may be cooled to a temperature of 20° C. (e.g., room temperature). Cooling may be cooling described with block 608.

The sum of the masses of the compounds used to generate the silicone gel elastomer may be characterized by a total mass. The amount of each material used may be based on the total mass. For example, the hydroxy silicone oil may be in a range from 70% to 74%, 74% to 86%, or 86% to 90% of the total mass. The boric acid may be in a range from 1% to 3%, 3% to 6%, or 6% to 9% of the total mass. The filler may be in a range from 5% to 10%, 10% to 16%, or 16% to 20% of the total mass. The oleic acid may be in a range from 0.1% to 0.3%, 0.3% to 1.5%, or 1.5% to 2.0% of the total mass. The benzoyl peroxide may be in a range from 0.1% to 0.5%, or 0.5% to 1.0% of the total mass. The sulfur may be in a range from 0.2% to 0.5%, 0.5% to 1.5%, or 1.5% to 2.0% of the total mass. The sum of all the percentages may equal 100%.

In some embodiments, the mass of each material may be based on the mass of the final elastomer. For example, the hydroxy silicone oil may be in a range from 70% to 74%, 74% to 86%, or 86% to 90% of the elastomer mass. The boric acid may be in a range from 1% to 3%, 3% to 6%, or 6% to 9% of the elastomer mass. The filler may be in a range from 5% to 10%, 10% to 16%, or 16% to 20% of the elastomer mass. The oleic acid may be in a range from 0.1% to 0.3%, 0.3% to 1.5%, or 1.5% to 2.0% of the elastomer mass. The benzoyl peroxide may be in a range from 0.1% to 0.5%, or 0.5% to 1.0% of the elastomer mass. The sulfur may be in a range from 0.2% to 0.5%, 0.5% to 1.5%, or 1.5% to 2.0% of the elastomer mass. The sum of all the percentages may equal 100%.

Blocks 602 to 612 may be performed in the kneader container. A shear stress or tensile stress may be applied to the silicone gel elastomer. The stress may be applied to test the silicone gel elastomer. In some embodiments, the stress may be applied as part of intended use of the silicone gel elastomer.

### Example Compositions

Embodiments of the present invention include silicone gel elastomers or shear thickening gels, which may be any disclosed herein. The silicone gel elastomers may be produced by method 600.

The silicone gel elastomer may include a copolymer formed from a series of reactions involving several compounds. The compounds may include hydroxy silicone oil, boric acid, benzoyl peroxide (also known as dibenzoyl peroxide), and oleic acid. The silicone gel elastomer may also include a filler and sulfur. The silicone gel elastomer may further include a vulcanization accelerator.

Hydroxy silicone oil may be a silicone polymer having hydroxyl functional groups. Hydroxy silicone oil may have a structure based on polydimethylsiloxane (PDMS) backbone with hydroxyl groups at terminal or side-chain positions. In some embodiments, boric acid may be replaced or supplemented with another acid having a boron atom (e.g., metaboric acid [HBO₂], tetraboric acid [H₂B₄O₇], polyboric acids [HₓB_{y}O_{z}], perboric acid [H₃BO₃—H₂O₂], boron hydrides, fluoroboric acid [HBF₄], boronic acids [R—B(OH)₂]).

In some embodiments, benzoyl peroxide may be replaced or supplemented with a peroxide having aromatic rings. For example, the peroxide may include diphenyl peroxide (C₆H₅—O—O—C₆H₅), benzoyl peroxide (C₆H₅COOOC₆H₅), tert-butyl peroxybenzoate (C₆H₅COOOC(CH₃)₃), phenyl peroxyacetate (C₆H₅OOCOCH₃), benzyl hydroperoxide (C₆H₅CH₂OOH), or anisoyl peroxide (C₆H₅OCH₃COOOC₆H₅OCH₃).

In some embodiments, oleic acid may be replaced or supplemented with another fatty acid, including a monounsaturated fatty acid and/or an omega-9 fatty acid. For example, replacements or supplements may include elaidic acid, palmitoleic acid, vaccenic acid, gadoleic acid, or erucic acid.

The filler may be inorganic. The filler may be hydrophobic. The filler may be characterized by an average (mean, median, or mode) particle size in a range from 30 to 50 nm, 50 to 100 nm, 100 to 200 nm, 200 to 300 nm, 300 to 400 nm, 400 to 500 nm, 500 to 600 nm, 600 to 700 nm, 700 to 800 nm, or 800 to 1000 nm. In some embodiments, the filler may include particles having sizes in any of these ranges. The filler may include white carbon black. White carbon black may be a precipitated silica. In some embodiments, the filler may include fumed silica, calcium carbonate, titanium dioxide, or alumina trihydrate. The filler may include an oxide, such as silicon dioxide, titanium dioxide, or alumina.

In some embodiments, sulfur may be substituted or supplemented with a different vulcanization agent. For example, the vulcanization agent may include a metal oxide (e.g., magnesium oxide, zinc oxide), a peroxide, acetoxysilane, or a urethane.

The vulcanization accelerator may include diphenyl guanine, diphenyguanidine (DPG), thazoles (e.g., 2-mercaptobenzothiazole [MBT], benzothiazyl disulfide [MBTS]), sulfenamides (e.g., N-Cyclohexyl-2-benzothiazolesulfenamide [CBS], N-Tert-Butyl-2-benzothiazolesulfenamide [TBBS]), thiurams (e.g., Tetramethylthiuram Disulfide [TMTD], Tetraethylthiuram Disulfide [TETD]), dithiocarbamates (e.g., Zinc Dimethyldithiocarbamate [ZDMC], Zinc Diethyldithiocarbamate [ZDEC]), or other guanidines).

The sum of the masses of hydroxy silicone oil, boric acid, benzoyl peroxide, oleic acid, white carbon black, sulfur, and the vulcanization accelerator may be a total mass. The hydroxy silicone oil may be in a range from 70% to 74%, 74% to 86%, or 86% to 90% of the total mass. The boric acid may be in a range from 1% to 3%, 3% to 6%, or 6% to 9% of the total mass. The filler may be in a range from 5% to 10%, 10% to 16%, or 16% to 20% of the total mass. The oleic acid may be in a range from 0.1% to 0.3%, 0.3% to 1.5%, or 1.5% to 2.0% of the total mass. The benzoyl peroxide may be in a range from 0.1% to 0.5%, or 0.5% to 1.0% of the total mass. The sulfur may be in a range from 0.2% to 0.5%, 0.5% to 1.5%, or 1.5% to 2.0% of the total mass. The sum of all the percentages may equal 100%.

The silicone gel elastomer may be characterized by a storage modulus increasing at least four orders of magnitude when an external shear frequency increases from 0.001 Hz to 100 Hz. The silicone gel elastomer may be characterized by a storage modulus and a loss modulus decreasing less than one order of magnitude when the temperature increases from 30 to 80° C. when an external shear frequency from 0.01 Hz to 100 Hz is applied. The silicone gel elastomer may be self-healing such that the storage modulus, loss modulus, complex modulus, and/or complex viscosity change by less than a threshold amount after a certain number of repeated shearing (including frequencies from 10⁻³ Hz to 10² Hz). The threshold amount may be less than 0.1%, 1.0%, 5.0%, or 10%. The certain number may be 2, 3, 4, 5, 6, 7, 8, 9, 10, 20, 30, or 50 times. The silicone gel elastomer may have any properties described herein.

### Example 4

A preparation method for fiber-reinforced composite structures containing the phase-transition and energy-absorbing gel for high toughness and impact resistance may be prepared with the following steps:
a) The STG was added to the volatile organic solvent (acetone or xylene) at the mixing mass ratio of 4:1 to 10:1 (solvent to STG). The stirring process involves 30-minute stirring sessions followed by 20-minute breaks. After each break, stirring was resumed for another 30 minutes, and this stirring-break cycle should be repeated until the STG was uniformly dispersed. The entire stirring and dissolving process continues for a total duration of 24 hours in a fume hood to ensure uniform dispersion of STG in the solution. To accelerate the dissolution, the solution was heated in the 40° C. water bath during stirring breaks.

In step a), adjusting the concentration of STG in the mixed solution allows for investigating the mechanical response and interaction of SACFRP laminates, which are prepared by curing different mass fractions of STG with fiber reinforced fabrics and epoxy for various impact conditions. This approach may allow exploring the action mechanism of STG and the structural stability of SACFRP at different ratios, enabling the optimization of the structural design and impact-resistant properties to meet diverse application requirements.

In step a), to prevent the organic solvent from volatilizing and becoming ineffective, measurement may be taken to minimize solvent evaporation during the stirring process, and the container may be sealed during the water bath heating.
b) The carbon fabrics were cut to the specified dimensions, and outer periphery of the fabrics was fixed with a clamping device or tape to ensure accuracy of the fabric shape and fiber orientations.
c) The cut fabrics need to be cleaned several times adopting ultrasonic oscillation at the frequency of 20 kHz to 40 kHz in a deionized water bath at 40° C. for 30 minutes until thoroughly cleaned. Once cleaning was complete, the carbon fabrics were taken out, rinsed with deionized water to eliminate any residual dirt, and then hung in a fume hood to dry.

In step c), the deionized water, free from dissolved salts, minerals and organic matter, was utilized to effectively clean dust, grease and other impurities on the surface of carbon fibers. The clean surface of the carbon fibers is helpful for subsequent bonding and coating for improved interfacial strength. Moreover, deionized water is mineral-free, which reduces the risk of scale formation during cleaning and contributes to preserving the structural integrity of carbon fibers. Consistent cleaning with deionized water also reduces uneven cleaning across different fiber sections.

In step c), before cleaning, the deionized water in the container may be preheated to 40° C. to enhance the decontamination ability and the cavitation effect of ultrasound, facilitating the dissolution of impurities and enabling more effective removal of dust and grease from the surface of carbon fibers. In addition, preheating can shorten the overall cleaning duration, improve the effectiveness and efficiency of cleaning, and reduce potential damage to the carbon fibers.
d) A glass syringe extracted a precise amount of STG-containing solution, which was then uniformly sprayed onto the cleaned and dried single-layer fabrics. A squeegee was used to scrape back and forth along the fiber directions, aiming to ensure that the solution is uniformly and completely impregnated in the entire carbon fabrics.

In step d), the use of the glass syringe can avoid reaction with organic solvents and ensure the purity and stability of the solution. Meanwhile, the glass syringe can provide precise measurement to ensure that the amount of the mixed solution applied to each layer of carbon fabric is consistent, thereby controlling the mass fraction of STG in the final SACFRP. Scraping along the fiber direction facilitates the penetration of the STG blend solution into the fiber bundles, enhancing wettability. Moreover, the scraping process can help remove bubbles generated during spraying, promote the dispersion and bonding of STG, ensure that STG is evenly distributed on the surface of carbon fibers, and improve adhesion of STG to the carbon fibers. This entire process is designed to ensure that the STG solution can be optimally bonded to the fabrics, thereby improving the overall performance and stability of SACFRP.

In step d), 20 mL of STG mixed solution can effectively infiltrate carbon fabrics over the area of 400 cm² to 625 cm².
e) The STG-impregnated carbon fabrics were put into a drying oven inside the fume hood for 24 hours to accelerate the volatilization of the organic solution. The fabrics may be turned over once every 12 hours to ensure even drying, thereby obtaining the dry STG-wrapped carbon fabrics.

In step e), the whole preparation process for the STG impregnated carbon fabrics may be conducted within a fume hood with proper ventilation to ensure safety.
f) The surfaces for both the bottom and top rigid molds may be smooth and free of foreign matter. Then, the vacuum bag and the peel ply were sequentially adhered to the upper surface of the bottom mold and the lower surface of the top mold using double-sided tape.

In step f), the vacuum bag and peel ply may be stretched and free of curling and wrinkles during the laying process.
g) Resin monomer and hardener was weighed with a graduated measuring cylinders and electronic scale, respectively, and then poured into a beaker. The mixture was stirred evenly using a glass stirrer to prepare the epoxy resin at a mass ratio of 10:3 for the monomer and hardener. Afterward, the prepared epoxy is placed in a vacuum machine set to 0.1 atmospheric pressure for 10 to 15 minutes to remove trapped air.

In step g), the 10:3 mass ratio aid the epoxy groups in the monomer reacting effectively with the active groups in the hardener, forming a stable cross-linking structure. Moreover, this formulation can produce the epoxy resin with excellent mechanical strength, chemical resistance, and high-temperature resistance, suitable for producing carbon or glass fiber composites for applications in aerospace, automobile, and construction. In addition, vacuum treatment can effectively remove bubbles in the epoxy resin and improve the densification and mechanical properties of the final product. Meanwhile, the vacuum environment can significantly reduce the viscosity of the resin and improve its flowability and permeability, thereby ensuring better infiltration into the carbon fabrics and improving the wettability and mechanical properties of the final composites.
h) According to the ply design, STG-wrapped carbon fabrics with different fiber angles were sequentially stacked on the upper surface of the bottom rigid mold. A glass syringe is used to spray 20 mL to 30 mL of epoxy over each layer of STG-wrapped carbon fabric, which is then evenly spread with a squeegee to ensure uniform and complete impregnation. During stacking, the STG-wrapped carbon fabrics were precisely aligned according to the designed fiber orientations.

In step h), reasonable design for fiber angle layup can improve the infiltration during the molding process and optimize the mechanical properties, stability, impact resistance and thermal expansion of the composite structures.
i) The top rigid mold was carefully placed onto the bottom rigid mold, which was covered with STG-wrapped carbon fabrics, ensuring direct contact between the fabrics and the peel ply while maintaining alignment between the upper and lower rigid molds. Then, a heat sealer was used to seal all four sides of the vacuum bag to prevent the epoxy leakage.
j) Multi-layer STG-wrapped carbon fabrics and epoxy were fabricated into fiber-reinforced composite structures using the compression molding technology. The mold was gently placed on the loading platform of the thermo-compressor. After adjusting the position, the protective door was closed, and the thermo-compressor was started. The molding pressure was set at 35.46 kPa, and the curing temperature was maintained at 80° C. for 8 hours during the compression molding.

In step j), the vacuum bag and the peel ply play key synergistic roles in the compression molding process, as they facilitate excellent resin infiltration and high-quality composite structures. During the compression molding process, the vacuum bag can be adhered to and deform with the carbon fabric to promote the flow and penetration of the epoxy. The peel ply with a microporous structure can provide a discharge channel for the resin in the vacuum bag, helping eliminate bubbles and assisting resin flow. Moreover, the peel ply can remain separated from the surface of the carbon fabric to prevent them from sticking together.
k) After completing the compression molding process, the mold was cooled to ambient temperature, and the fiber-reinforced composite structures containing the phase-transition and energy-absorbing gel for high toughness and impact resistance can be obtained.

### Example 5

An example of preparing a SACFRP composite is described.

### Step (1): Preparation of STG

STG is prepared according to Example 2.

### Step (2): Preparation of the STG Mixing Solution and Fabric

A total of 200 g of STG prepared in Step (1) is added to 1000 g of xylene solution in a glass container. The mixing process involves alternating stirring and resting statuses: stirring for 30 minutes, followed by 20-minute break. The stirring-resting cycle is repeated continuously for 24 hours in a fume hood to ensure uniform dispersion of STG in the solution. To accelerate the dissolution of STG, the solution is heated in a water bath at 40° C. during each break status. To prevent volatilization and maintain the effectiveness of the organic solvent, the glass container is sealed throughout the stirring and water bath heating process. In this process, the solution of different concentration ratios can be prepared by adjusting the mass ratio of STG to xylene.

During cutting, the fabric is securely fixed on the experimental platform with a clamping device or a tape to prevent distortion and maintain fiber orientations, ensuring the intended size specifications. Then, the carbon fabrics are cut into 21 cm×21 cm sections with electric scissors.

The deionized water, filling more than half of the capacity of the container, is poured into the ultrasonic cleaner. The heating function is activated to raise and maintain the water temperature to 40° C. The cut fabrics are then fully submerged in the heated deionized water. The ultrasonic oscillation frequency is adjusted to 40 kHz, and the cleaning function is activated for 30 minutes. The fabrics are cleaned several times until no contaminants remain. Once cleaning is complete, the carbon fabrics are rinsed with deionized water to remove any remaining impurities and then hung in a fume hood to dry.

### Step (3): Preparation of STG-Wrapped Carbon Fiber Fabric

The cleaned and dried single-layer fabric is laid flat on a smooth and clean metal platform in the fume hood. A glass syringe is adopted to obtain 20 mL of STG-containing solution, which is uniformly sprayed onto the single-layer fabrics. A squeegee is used to scrape back and forth appropriately along the fiber directions, ensuring uniform impregnation while removing any bubbles formed during the spraying process.

The impregnated carbon fabrics, along with metal plates, are placed in the fume hood to dry for 20 minutes. Afterward, the carbon fabric is removed from the metal plate, flipped over, and laid flat again with the opposite side facing up for an additional 20 minutes of drying. Once the surface solvent has sufficiently volatilized, the carbon fabric is detached from the metal plate and transferred to a drying oven inside the fume hood. The oven temperature is set to 50° C., and the fabric is dried for 24 hours to accelerate the volatilization of the organic solution. This process results in the formation of dry STG-wrapped carbon fabrics.

### Step (4): Preparation of STG-Applied Carbon Fiber Reinforced Polymer (SACFRP) Composites

The vacuum bags are cut into 50 cm×50 cm squares, while the peel plies are cut into 30 cm×30 cm squares. The single-layer vacuum bag and the peel ply are sequentially adhered to the upper surface of the bottom rigid mold and the lower surface of the top rigid mold using double-sided tape. During the laying process, both the vacuum bags and peel plies may remain stretched without curling and wrinkles.

The resin monomer with mass of 120 g and hardener with mass of 36 g are weighed using a measuring cylinders and an electronic scale, respectively, and poured into a glass beaker. Then, the mixed solution is stirred evenly using a glass stirrer to prepare the epoxy resin with the monomer-to-hardener mass ratio of 10:3. The prepared epoxy resin is placed in a vacuum machine set to 0.1 atmospheric pressure for 10 to 15 minutes to remove any trapped air.

According to the ply design with the stacking sequence of [45/90/135/0]ₛ for quasi-isotropic properties, STG-wrapped carbon fabrics with different initial fiber orientations are sequentially stacked onto the bottom rigid mold. For each layer, 20 mL of epoxy is applied using a glass syringe and spread evenly with a squeegee to aid uniform impregnation to the entire carbon fabrics. STG-wrapped carbon fabrics are aligned to the designed orientations.

The top rigid mold is placed on the bottom rigid mold covered with STG-wrapped carbon fabrics, so that the fabrics are in direct contact with the peel ply and aligned well with the upper and lower molds. Then, the four sides of the vacuum bag are sequentially sealed using a heat sealer to prevent the epoxy leakage.

### Step (5): Preparation of SACFRP Composite Structure Based on Compression Molding

The mold is positioned on the loading platform of the thermo-compressor. After adjusting the position, the protective door is closed, and the thermo-compressor is started. The molding pressure is set to 35.46 kPa, and the curing temperature is set to 80° C. The composite undergoes compression molding and curing for 8 hours.

When the compression molding is completed, the mold is cooled to ambient temperature. The fiber-reinforced composite structures with high-toughness and impact-resistant based on the phase-transition and energy-absorbing gel can be obtained.

### Example 6

### Density and Bonding State of Each Component in the SACFRP

To highlight the performance of the SACFRP composite structures prepared in the present invention, reference CFRP laminates were also fabricated without introducing the STG, while keeping all the other materials and processing conditions unchanged. The density and bonding state of each component in SACFRP and CFRP were compared and analyzed.

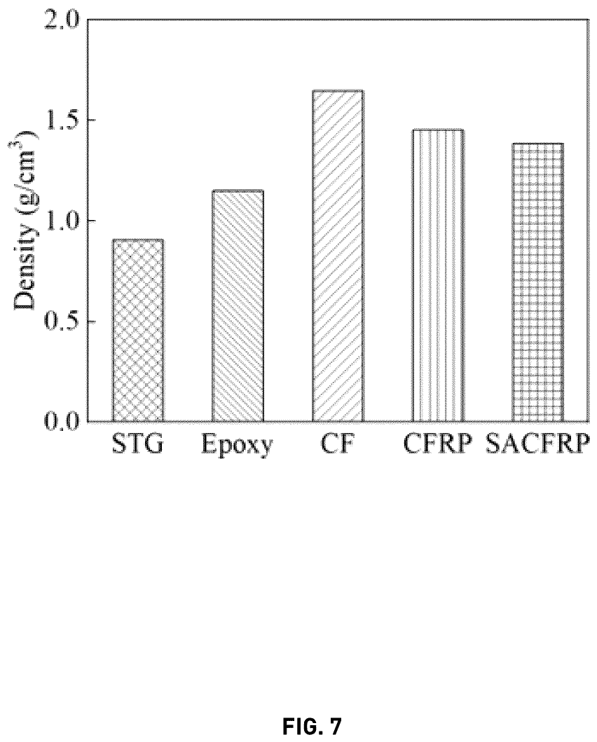

FIG. 7 is a graph comparing densities for different composites and their constituents. The density in g/cm³ is shown on the y-axis. The composite or constituent is shown on the x-axis. CF stands for carbon fibers. The density of the STG prepared in this disclosure is 0.906 g/cm³, which is lower than that of the epoxy matrix in the CFRP. The density of SACFRP prepared by combining STG and epoxy is 1.385 g/cm³, which is 4.68% lower than that of the reference CFRP. The density of the SACFRP is lower than the density of CFRP, indicating that the improved performance of SACFRP is not due to a heavier constituent. The density decrease results at least partly from substituting epoxy with lighter STG.

Table 1 shows the mass fraction of each component in SACFRP laminate structures. Table 2 shows the mass fraction of each component in the reference CFRP structures. Notably, the fiber mass fraction values in both SACFRP and reference CFRP laminates prepared in this disclosure were controlled to remain similar to the values in Table 1 and Table 2. Density and other properties may vary based on the mass fraction of components.

TABLE 1
Constituent mass fraction of SACFRP.

| Component | Mass fraction (%) |
|---|---|
| Carbon fibers | 71.2 |
| Epoxy | 11.9 |
| STG | 16.9 |

TABLE 2
Constituent mass fraction of CFRP.

| Component | Mass fraction (%) |
|---|---|
| Carbon fibers | 70.1 |
| Epoxy | 29.9 |

### Imaging

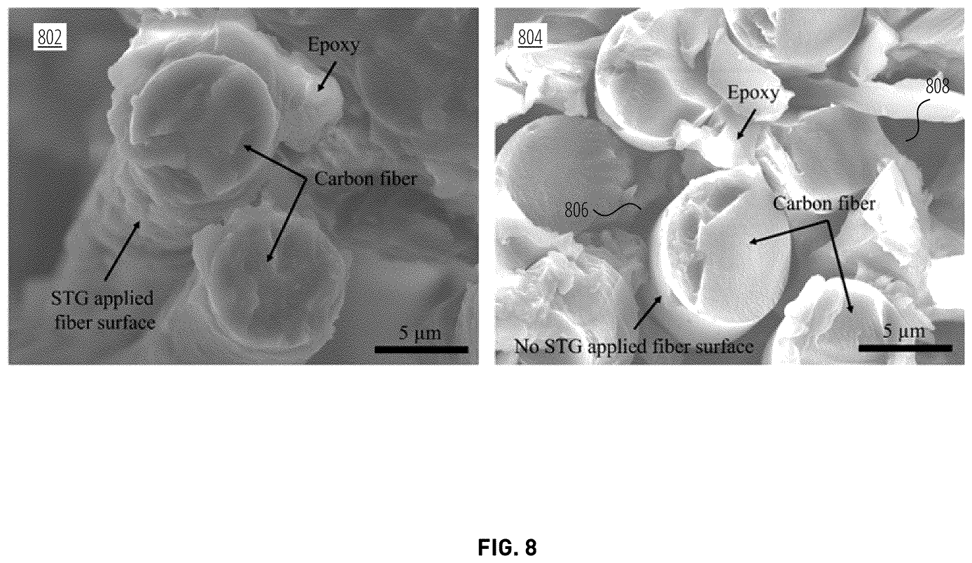

FIG. 8 shows scanning electron microscope (SEM) images of composites. Image 802 is an image of a SACFRP composite. Image 804 is an image of a reference CFRP composite.

The epoxy adhesion to fiber surface in the reference CFRP is limited, leading to suboptimal bonding. For example, gaps (e.g., gaps 806 and 808) with no epoxy are visible between carbon fibers. By contrast, image 802 illustrates that SACFRP exhibits enhanced adhesion between carbon fibers and the epoxy-STG matrix. Specifically, the epoxy and STG in the SACFRP composites not only fill in the gaps between fiber bundles but also provide better overall wrapping of individual fibers. The addition of STG significantly improves matrix-fiber adhesion.

Without intending to be bound by theory, the better gap-filling in SACFRP may be the result of STG having the ability to flow, and the tendency for epoxy to shrink when hardened. STG can deform, and rigid structural composites with STG may be able to withstand both static and dynamic loading.

### Static Mechanical Properties of the SACFRP Composite Laminates

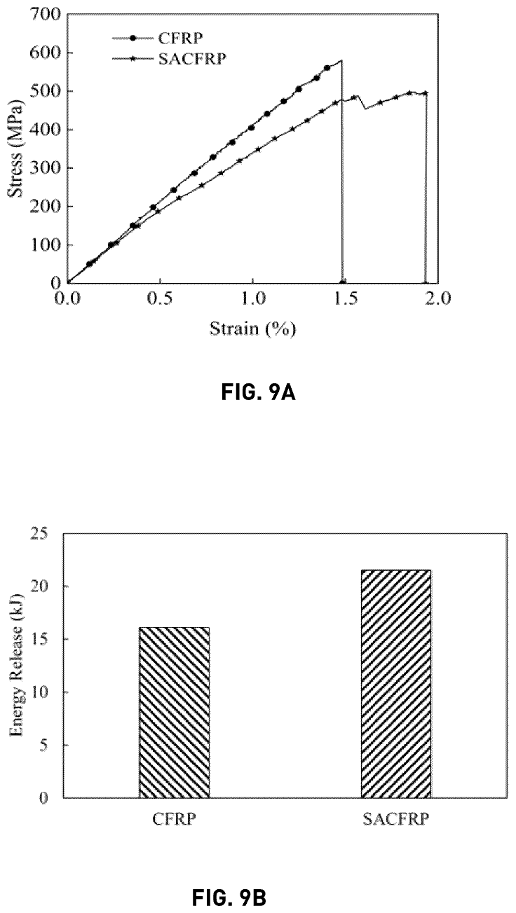

Mechanical properties of the SACFRP and reference CFRP laminates were evaluated under tensile loading. FIG. 9A shows the stress in MPa on the y-axis and the strain (%) on the x-axis. The circle data points represent the CFRP laminate, and the star data points represent the SACFRP laminate.

FIG. 9A indicates that failure strain of the SACFRP is significantly larger than that of the reference CFRP. Specifically, the ultimate strain of the SACFRP is approximately 1.94%, which is 31.1% higher than that of the corresponding CFRP with the ultimate strain of around 1.5%.

FIG. 9B is a graph of energy release/toughness prior to the complete destruction for both the SACFRP and CFRP. The energy release in kJ is shown on the y-axis. The composite type is shown on the x-axis. The SACFRP exhibits approximately 33.35% increase in energy release/toughness compared to that of the CFRP, demonstrating superior toughness of the SACFRP. The energy release shows a similar trend to that of the ultimate failure strain in FIG. 9A. The energy release is related to the area under the curves in FIG. 9A. These results show that the SACFRP can absorb greater energy than a CFRP, indicating the usefulness of SACFRP in applications where the composite should be soft and absorb energy, such as in a car crash.

### Impact Resistance Properties

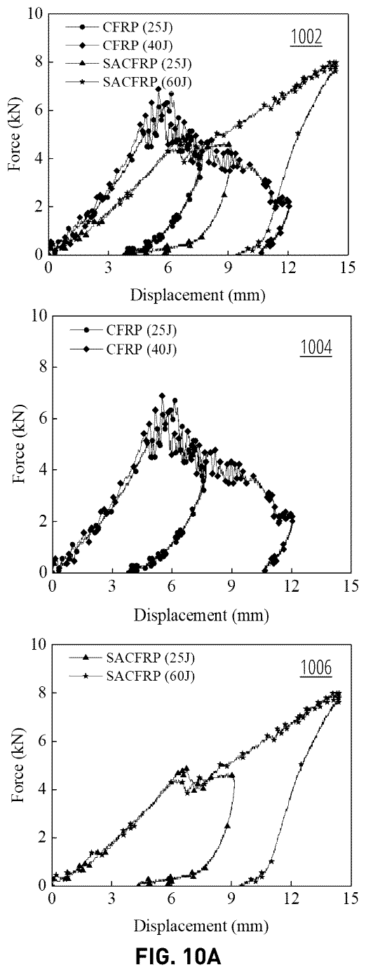

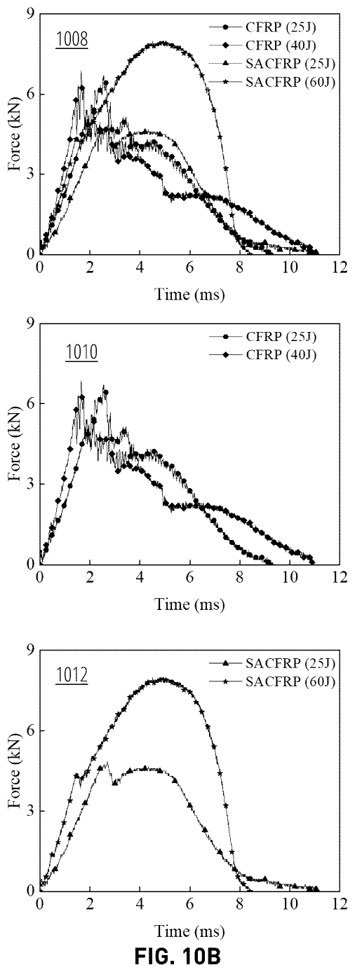

The SACFRP and reference CFRP laminates undergo LVI tests under different impact energy levels. FIG. 10A shows graphs with force in kN on the y-axis and displacement in mm on the x-axis. Graph 1002 shows data from CFRP laminates tested with 25 J and 40 J of impact energy and from SACFRP laminates tested with 25 J and 60 J of impact energy. Graph 1004 shows data from just the CFRP laminates. Graph 1006 shows data from just the SACFRP laminates.

FIG. 10A shows that the CFRP laminates exhibit typical brittle behavior with stiffer initial response (e.g., a higher force for the same displacement) compared to the SACFRP laminates at low impact energy. The introduction of STG into SACFRP altered the response of the laminates, resulting in more ductile behavior. Specifically, the SACFRP demonstrates the reduced peak force of 4.77 kN, while its maximum displacement increases by 20.1% compared to that of the CFRP. When the force returns to zero, the SACFRP laminate at 25 J has a similar displacement as the CFRP laminate at 25 J. When the force returns to zero, the SACFRP laminate at 60 J has a lower displacement than the CFRP laminate at a lower energy impact of 40 J.

Graph 1004 shows that, at different impact energy, the CFRP laminates exhibit a stiffer initial response and more abrupt load drop, indicative of typical brittle failure behavior. As seen in graph 1006, the SACFRP samples, in contrast, demonstrate a more gradual force-displacement evolution, suggesting enhanced damage tolerance and energy absorption.

FIG. 10B shows graphs of the force-time curves of the CFRP and SACFRP laminates during the LVI tests with different impact energy. FIG. 10B has graphs with force in kN on the y-axis and time in ms on the x-axis. FIG. 10B includes the same tests used in FIG. 10A but time is plotted instead of displacement. Graph 1008 shows results for CFRP and SACFRP laminates. Graph 1010 shows results for CFRP laminates. Graph 1012 shows results for SACFRP laminates. As seen in graph 1010, the results for SACFRP at 25 J and 60 J show relatively smooth curves, indicating a lack of fractures in the composite. By contrast, in graph 1010, the results for CFRP at 25 J and 40 J show oscillations in the curves, indicating fractures in the composite. FIG. 10B shows that SACFRP has a preferred force-time curve compared to CFRP.

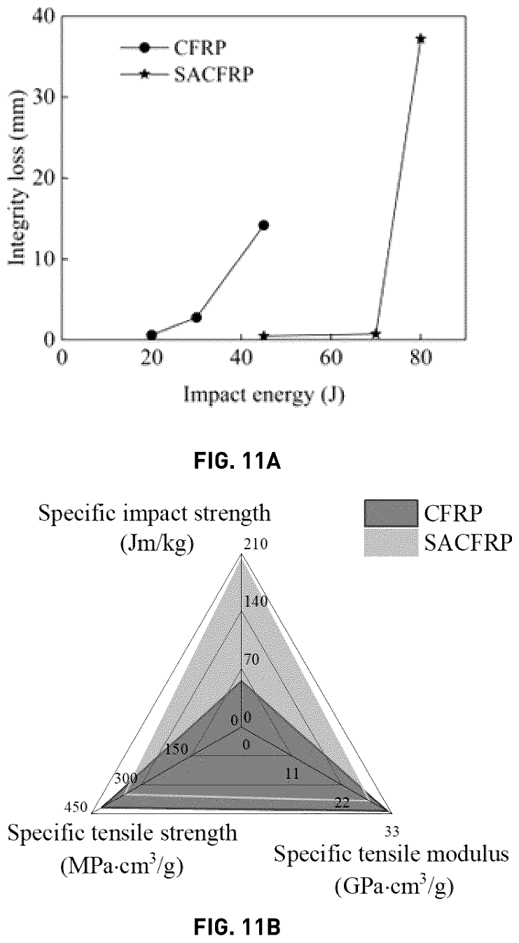

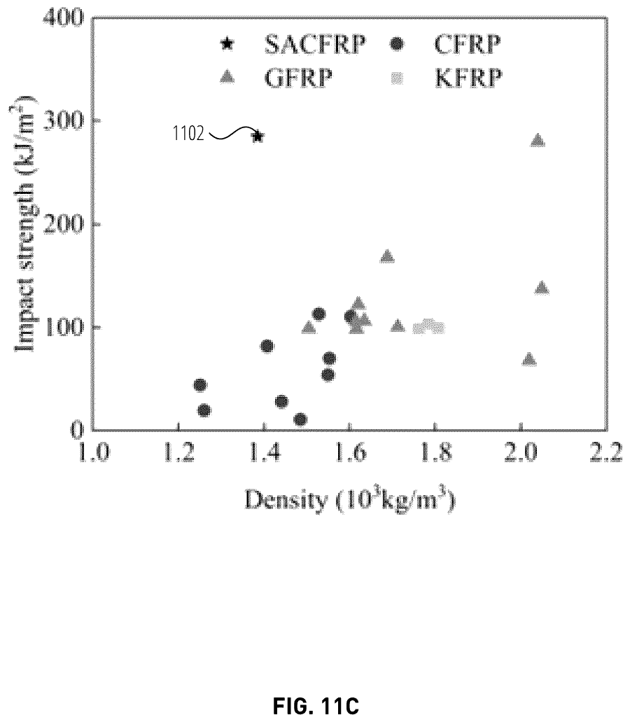

FIG. 11A is a graph of the integrity loss for the LVI tests. FIG. 11A has impact energy in J on the x-axis and integrity loss in mm on the y-axis. FIG. 11A includes CFRP laminate results for 20 J, 30 J, and 45 J of impact energy. FIG. 11A includes SACFRP laminate results for 45 J, 70 J, and 80 J of impact energy.

A large integrity loss indicates deformation of the composite, which is not desired in a composite. FIG. 11A shows that CFRP at 45 J of impact energy suffers a significant integrity loss. In contrast, SACFRP at 45 J of impact energy shows little integrity loss. SACFRP at 70 J also shows little integrity loss. Only at 80 J of impact energy does SACFRP show significant integrity loss. FIG. 11A shows that SACFRP has less deformation than CFRP for the same impact energy.

FIG. 11B is a comparative radar plot for the specific impact strength, specific tensile strength and specific tensile modulus of the SACFRP and reference CFRP. The top vertex of the plot is the specific impact strength in J m/kg. The left vertex is specific tensile strength in MPa cm³/g. The right vertex shows specific tensile modulus in GPa·cm³/g.

The LVI tests indicated that the specific impact strength of the SACFRP is significantly higher, increasing by 267% compared to that of the CFRP with the same carbon fibers and epoxy resin but without the STG. Moreover, specific impact strength of the SACFRP reaches 202 J·m/kg, which is the highest among all the existing fiber reinforced polymer (FRP) composites, effectively overcoming the brittleness of CFRP.

The specific tensile strength of SACFRP (349.84 MPa cm³/g) is slightly lower than that of CFRP (418.57 MPa cm³/g). The specific tensile modulus of SACFRP (28.11 GPa·cm³/g) is slightly lower than that of CFRP (32.02 GPa·cm³/g). The advantages of the significantly higher specific impact strength of SACFRP may overcome any disadvantages of the lower specific tensile strength and specific tensile modulus. Changes in formulation of the SACFRP may reduce or eliminate any differences with CFRP in specific tensile strength and/or specific tensile modulus.

FIG. 11C is a graph of a comparison of impact strength versus density for SACFRP against other composites from literature. The graph has density in 103 kg/m³ on the x-axis and impact strength in kJ/m² on the y-axis. Besides SACFRP and CFRP, the impact strengths of GFRP (glass fiber reinforced polymer) and KFRP (Kevlar fiber reinforced polymer) are also plotted. Point 1102 represents SACFRP. Point 1102 has the highest impact strength while being on the lower end for density. The remaining points for the polymer composites that are not SACFRP show a general relationship of increasing impact strength with higher densities. SACFRP surprisingly breaks this relationship.

The durabilities of the reference CFRP and SACFRP structures under repeated impact were also compared and analyzed. The experimental results listed in Table 1 show that the presence of STG increases the toughness of the carbon fabric composites under repeated impact, allowing for greater energy absorption. Additionally, proper design of the stacking sequences can slow down the expansion of cracks, maintaining the integrity of the composites and improving the impact resistance of the overall structures. The SACFRP exhibits superior performance under multiple repeated impacts, with the capability to withstand 31 consecutive impacts under 45 J energy without penetrating damage. In contrast, the reference CFRP was completely penetrated by just one impact with 45 J energy. As a result, SACFRP is an improved material for applications requiring resistance to multiple or frequent impacts, providing better safety and reliability.

TABLE 3
Durability of the reference CFRP and SACFRP
composite structures under repeated impacts.

| | | Impact times until |
|---|---|---|
| Specimen | Impact energy | perforation |
| CFRP | 20 J | 2 |
| | 25 J | 2 |
| | 30 J | 2 |
| | 35 J | 2 |
| | 40 J | 1 |
| | 45 J | 1 |
| SACFRP | 45 J | 31 |
| | 60 J | 18 |
| | 70 J | 2 |
| | 80 J | 1 |

### Example Methods for Composites

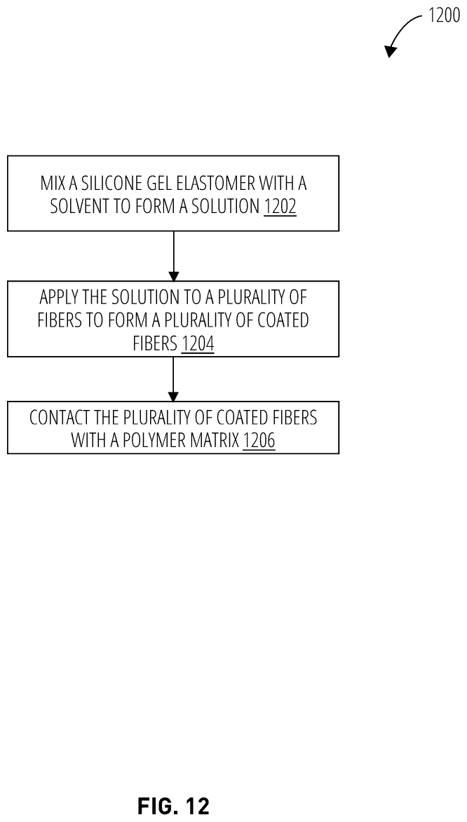

FIG. 12 shows a method for preparing a composite, including a fiber-reinforced composite. The fiber-reinforced composite may be SACFRP or any composite described herein.

In block 1202, method 1200 mixes a silicone gel elastomer with a solvent to form a solution. The silicone gel elastomer may include a copolymer formed from reactions of compounds. The compounds may include hydroxy silicone oil, boric acid, benzoyl peroxide, and oleic acid. The silicone gel elastomer may include a filler and sulfur. The silicone gel elastomer may be any silicone gel elastomer described herein. The solvent may be an organic solvent. The solvent may be a volatile organic solvent. The solvent may be xylene or acetone. Method 1200 may include the steps of method 600.

A mass ratio of the solvent to the silicone gel elastomer may be in a range from 4:1 to 10:1, 3:1 to 4:1, 4:1 to 5:1, 5:1 to 6:1, 6:1 to 7:1, 7:1 to 8:1, 8:1 to 9:1, 9:1 to 10:1, or 10:1 to 11:1.

Forming the solution may involve agitation (e.g., stirring) to dissolve the elastomer. Stirring may take 0.1 to 1 h, 1 to 5 h, 5 to 10 h, 10 to 12 h, 12 to 24 h, or greater than 24 h. In embodiments, stirring may not take the whole time, but the duration may be split between periods of stirring and periods of rest. For example, stirring may occur for 30 minutes with a break of 20 minutes before another 30 minutes of stirring. Formation of the solution may include heating. The solution may be heated to a temperature in a range of 40 to 50° C., 50 to 60° C., or greater than 60° C.

In block 1204, method 1200 applies the solution to a plurality of fibers to form a plurality of coated fibers. An amount of the solution applied to the plurality of fibers is 0.03 to 0.05 mL of solution per 1 cm² area of the plurality of fibers. The amount may be in a range of 0.02 to 0.03 mL/cm², 0.03 to 0.04 mL/cm², 0.04 to 0.05 mL/cm², or 0.05 to 0.06 mL/cm². The fibers may be coated by a spray applicator. In some embodiments, a squeegee, a scraper, or other suitable device may be used to spread the solution more evenly over the fibers. The plurality of fibers may be in the form of a fabric. The fibers may be cleaned with water, ultrasonic, and/or heat before the solution is applied.

The coated fibers may be heated in order to evaporate the solvent. The coated fibers may be heated to a temperature of 50° C., or in a range from 40 to 50° C., 50 to 60° C., or 60 to 70° C. The duration of heating may be in a range from 0.1 to 1 h, 1 to 5 h, 5 to 10 h, 10 to 12 h, 12 to 24 h, or greater than 24 h.

In block 1206, method 1200 contacts the plurality of coated fibers with a polymer matrix. The polymer matrix may be any polymer matrix described herein. The polymer matrix may be an epoxy resin. The epoxy resin may be formed with a mass ratio of monomer to hardener in a range from 3:1 to 4:1, 2:1 to 3:1, or 4:1 to 5:1. The amount of polymer matrix applied to the plurality of coated fibers may be in a range of 0.02 to 0.03 mL/cm², 0.03 to 0.04 mL/cm², 0.04 to 0.05 mL/cm², or 0.05 to 0.06 mL/cm².

Method 1200 may further include molding (e.g., compression molding) the plurality of coated fibers and the polymer matrix after contacting the coated fibers with the polymer matrix. The molding may include heating at a temperature of 80° C., or in a range from 70 to 80° C., 80 to 90° C., or 90 to 100° C. The molding may be performed at a pressure in a range from 30 to 40 kPa, or 20 to 30 kPa, or 50 to 60 kPa. The mold may be cooled to ambient temperature.

During molding, a vacuum bag, peel ply, and the plurality of coated fibers may be placed on the bottom rigid mold. Another vacuum bag and peel ply may be placed below the top rigid mold.

The plurality of coated fibers may be a first layer of coated fibers. Method 1200 may further include contacting the polymer matrix with a second layer of coated fibers. Additional layers may be included. The composite may be arranges as layers of coated fibers separated at least in part by the polymer matrix.

In some embodiments, the fibers in the composite may be unidirectional. In some embodiments, the fibers may be woven. In some embodiments, layers may have different directions. For example, adjacent layers may alternate directions of fibers. Adjacent layers may have fiber directions offset by an angle (e.g., 10 degrees, 30 degrees, 45 degrees, 60 degrees, 90 degrees).

### Example Composites

Embodiments may include a fiber-reinforced composite produced by method 1200 or any method described herein.

Embodiments may include a fiber-reinforced composite. The fiber-reinforced composite may be any fiber-reinforced composite described herein. The fiber-reinforced composite may include a plurality of fibers. The plurality of fibers may include carbon fibers, glass fibers, aramid (Kevlar), or natural fibers (e.g., hemp or flax). Glass fibers may include E-glass, S-glass, or R-glass.

The diameter of fibers may be in a range from 1 to 5 m, 5 to 10 m, 10 to 20 m, 20 to 30 m, 30 to 50 m, or 50 to 100 m. Lengths of fibers may be in a range from 0.1 to 1 cm, 1 cm to 5 cm, 5 cm to 10 cm, or greater than 10 cm. Fibers may be bundled into tows containing 1,000 to 50,000 individual filaments (designated as 1K to 50K). Fiber architectures may include unidirectional tapes with thicknesses typically ranging from 0.125 to 0.5 mm, woven fabrics in plain, twill, and satin weaves with areal weights between 100 to 1,500 g/m², or three-dimensional preforms including braided, stitched, and z-pinned configurations. Multi-layer laminates may be constructed by stacking individual plies at specific orientations, commonly following quasi-isotropic layup sequences such as [0°/45°/−45°/90° ]s. The total laminate thicknesses may range from 1 mm to 50 mm or over 50 mm. Individual ply thickness may range from 0.1 to 0.3 mm.

The fiber-reinforced composite may include a polymer matrix. The polymer matrix may include an epoxy, a thermoset polymer, or a thermoplastic polymer. Thermosetting polymers may include epoxy resins, unsaturated polyester resins, vinyl ester resins, phenolic resins, or bismaleimide resins. Thermoplastic matrices include polyetheretherketone (PEEK), polyphenylene sulfide (PPS), or polyamide systems. The fiber-reinforced composite may include bio-based and sustainable matrix options, such as natural rubber, plant-derived polyols, and lignin-based systems.

In some embodiments, the fiber-reinforced composite may include a ceramic matrix or a metallic matrix. Ceramic matrix materials may include silicon carbide, alumina, and carbon-carbon composites. Metal matrix may include aluminum, titanium, magnesium, or alloys thereof.

The fibers may be coated with a functional interfacial layer, such as a silicone gel elastomer, which may be applied prior to matrix infusion to enhance damping or energy absorption. The use of a ceramic or metallic matrix may be assist with high-temperature, high-stress, or thermally conductive applications.

Epoxy resins may be formed through the reaction of epoxide-containing compounds with hardening agents. As an example, an epoxy resin is diglycidyl ether of bisphenol A (DGEBA), synthesized by reacting bisphenol A with epichlorohydrin in the presence of sodium hydroxide, which creates a resin with terminal epoxide groups that can react with various curing agents including aliphatic and aromatic amines, anhydrides, and catalytic systems. Other epoxy resins include novolac epoxy resins, derived from phenol-formaldehyde novolac resins through glycidylation; cycloaliphatic epoxy resins, formed from cyclohexene oxide derivatives; flexible epoxy systems that incorporate polyether or polyester segments into the backbone structure, either through the resin formulation or by using flexible amine hardeners such as polyoxypropylene diamines; or formulations that include reactive diluents such as butyl glycidyl ether or phenyl glycidyl ether, accelerators like tertiary amines or imidazoles, or toughening agents such as carboxyl-terminated butadiene-acrylonitrile (CTBN) rubber or thermoplastic particles.

The fiber-reinforced composite may include a silicone gel elastomer. The silicone gel elastomer may include a copolymer formed from reactions of compounds. The compounds may include hydroxy silicone oil, boric acid, benzoyl peroxide, and oleic acid. The silicone gel elastomer may include a filler and sulfur. The silicone gel elastomer may be any silicone gel elastomer described herein.

Each fiber of the plurality of fibers may be coated with the silicone gel elastomer. The thickness of the coating may be in a range from 50 to 100 nm, 100 to 200 nm, 200 to 300 nm, 300 to 500 nm, 500 nm to 1 m, 1 m to 2 m, or greater than 2 m.

The mass fraction of the silicone gel elastomer to the plurality of fibers may be in a range from 0.10 to 0.30, 0.05 to 0.10, 0.10 to 0.20, 0.20 to 0.30, or 0.30 to 0.40. The mass fraction of the silicone gel elastomer to the polymer matrix may be in a range from 1.1 to 1.5, 1.0 to 1.1, 1.1 to 1.2, 1.2 to 1.3, 1.3 to 1.4, 1.4 to 1.5, or 1.5 to 1.6. The mass fraction of the polymer matrix to the plurality of fibers may be in a range from 0.10 to 0.30, 0.05 to 0.10, 0.10 to 0.20, 0.20 to 0.30, or 0.30 to 0.40.

The silicone gel elastomer may be 10% to 20%, 5% to 10%, 10% to 15%, 15% to 20%, 20% to 25%, or 25% to 30% by mass of the fiber-reinforced composite. The polymer matrix may be 10% to 20%, 5% to 10%, 10% to 15%, 15% to 20%, 20% to 25%, or 25% to 30% by mass of the fiber-reinforced composite. The plurality of fibers may be 60% to 80%, 50% to 60%, 60% to 70%, 70% to 80%, or 80% to 90% by mass of the fiber-reinforced composite.

The fiber-reinforced composite may be characterized by a density in a range from 1.3 to 1.4 g/cm³, 1.2 to 1.3 g/cm³, or 1.4 to 1.5 g/cm³. The fiber-reinforced composite may be characterized by a specific impact strength in a range from 200 to 210 J·m/kg, 150 to 180 J m/kg, 180 to 200 J·m/kg, 210 to 230 J·m/kg, or greater than 230 J·m/kg.

Any of the methods described herein may be totally or partially performed with a computer system including one or more processors, which can be configured to perform the steps. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order that is logically possible. Additionally, portions of these steps may be used with portions of other steps from other methods. Also, all or portions of a step may be optional. Additionally, any of the steps of any of the methods can be performed with modules, units, circuits, or other means of a system for performing these steps.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

The above description of example embodiments of the present disclosure has been presented for the purposes of illustration and description and are set forth so as to provide those of ordinary skill in the art with a complete disclosure and description of how to make and use embodiments of the present disclosure. It is not intended to be exhaustive or to limit the disclosure to the precise form described nor are they intended to represent that the experiments are all or the only experiments performed. Although the disclosure has been described in some detail by way of illustration and example for purposes of clarity of understanding, it is readily apparent to those of ordinary skill in the art in light of the teachings of this disclosure that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the disclosure being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

A recitation of “a”, “an” or “the” is intended to mean “one or more” unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

The claims may be drafted to exclude any element which may be optional. As such, this statement is intended to serve as antecedent basis for use of such exclusive terminology as “solely”, “only”, and the like in connection with the recitation of claim elements, or the use of a “negative” limitation.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within embodiments of the present disclosure. The upper and lower limits of these smaller ranges may independently be included or excluded in the range, and each range where either, neither, or both limits are included in the smaller ranges is also encompassed within the present disclosure, subject to any specifically excluded limit in the stated range. Where the stated range includes one or both of the limits, ranges excluding either or both of those included limits are also included in the present disclosure.

The term “about” or “approximately” can mean within an acceptable error range for the particular value as determined by one of ordinary skill in the art, which will depend in part on how the value is measured or determined, i.e., the limitations of the measurement system. For example, “about” can mean within 1 or more than 1 standard deviation, per the practice in the art. Alternatively, “about” can mean a range of up to 20%, up to 10%, up to 5%, or up to 1% of a given value. Alternatively, particularly with respect to biological systems or processes, the term “about” or “approximately” can mean within an order of magnitude, within 5-fold, and more preferably within 2-fold, of a value. Where particular values are described in the application and claims, unless otherwise stated the term “about” meaning within an acceptable error range for the particular value should be assumed. The term “about” can have the meaning as commonly understood by one of ordinary skill in the art. The term “about” can refer to ±10%. The term “about” can refer to ±5%. Any exact number described herein may be modified with “about” or “approximately.”

All patents, patent applications, publications, and descriptions mentioned herein are hereby incorporated by reference in their entirety for all purposes as if each individual publication or patent were specifically and individually indicated to be incorporated by reference and are incorporated herein by reference to disclose and describe the methods and/or materials in connection with which the publications are cited. None is admitted to be prior art.

Embodiments may include the following:
Embodiment 1. A silicone gel elastomer, the silicone gel elastomer comprising: a copolymer formed from reactions of compounds comprising: hydroxy silicone oil, boric acid, benzoyl peroxide, and oleic acid; a filler; and sulfur.
Embodiment 2. The silicone gel elastomer of embodiment 1, further comprising a vulcanization accelerator.
Embodiment 3. The silicone gel elastomer of embodiment 2, wherein: a sum of the masses of hydroxy silicone oil, boric acid, benzoyl peroxide, oleic acid, white carbon black, sulfur, and the vulcanization accelerator is a total mass; the hydroxy silicone oil is in a range from 74% to 86% of the total mass; the boric acid is in a range from 3% to 6% of the total mass; the filler is in a range from 10% to 16% of the total mass; the oleic acid is in a range from 0.3% to 1.5% of the total mass; the benzoyl peroxide is in a range from 0.1% to 0.5% of the total mass; and the sulfur is in a range from 0.5% to 1.5% of the total mass.
Embodiment 4. The silicone gel elastomer of embodiment 1, wherein the filler is white carbon black.
Embodiment 5. The silicone gel elastomer of embodiment 1, wherein the silicone gel elastomer is characterized by the storage modulus increasing 4 orders of magnitude when an external shear frequency increases from 0.001 Hz to 100 Hz.
Embodiment 6. The silicone gel elastomer of embodiment 1, wherein the filler is characterized by a median particle size in a range from 50 to 800 nm.
Embodiment 7. The silicone gel elastomer of embodiment 1, wherein the silicone gel elastomer is characterized by the storage modulus and the loss modulus decreasing by less than 1 order of magnitude when the temperature increases from 30 to 80° C. when an external shear frequency from 0.01 Hz to 100 Hz is applied.
Embodiment 8. The silicone gel elastomer of embodiment 1, wherein the silicone gel elastomer is characterized by a storage modulus curve with a varying applied frequency that is within 1% of a storage modulus curve with a previous varying applied frequency.
Embodiment 9. A method of preparing a silicone gel elastomer, the method comprising: reacting hydroxy silicone oil with boric acid to form a borate ester compound; mixing the borate ester compound with benzoyl peroxide to form a cross-linked mixture; adding oleic acid to the cross-linked mixture to form a borate-oleate copolymer; adding a filler to the borate-oleate copolymer to form a first colloid; adding sulfur to the first colloid to form a second colloid; and heating the second colloid to form the silicone gel elastomer.
Embodiment 10. The method of embodiment 9, further comprising adding a vulcanization accelerator to the first colloid to form the second colloid.
Embodiment 11. The method of embodiment 10, further comprising stirring the second colloid at a temperature in a range from 80 to 100° C. for a duration in a range of 2 to 4 hours.
Embodiment 12. The method of embodiment 9, wherein: the silicone gel elastomer is characterized by a total mass; or the hydroxy silicone oil is in a range from 74% to 86% of the total mass; or the boric acid is in a range from 3% to 6% of the total mass; or the filler is in a range from 10% to 16% of the total mass; or the oleic acid is in a range from 0.3% to 1.5% of the total mass; or the benzoyl peroxide is in a range from 0.1% to 0.5% of the total mass; or the sulfur is in a range from 0.5% to 1.5% of the total mass.
Embodiment 13. The method of embodiment 9, wherein the filler is white carbon black.
Embodiment 14. The method of embodiment 9, wherein reacting the hydroxy silicone oil with the boric acid comprises placing the hydroxy silicone oil with the boric acid in a kneader container for a duration in a range from 1 hour to 2 hours.
Embodiment 15. The method of embodiment 14, wherein reacting the hydroxy silicone oil with the boric acid further comprises reacting at a pressure in a range from 13 to 14 kPa and a temperature in a range from 70 to 80° C.
Embodiment 16. The method of embodiment 9, wherein adding the oleic acid to the cross-linked mixture occurs at least 2 hours after mixing the borate ester compound with the benzoyl peroxide.
Embodiment 17. The method of embodiment 16, wherein mixing the borate ester compound with the benzoyl peroxide is at a temperature in a range from 150 to 180° C.
Embodiment 18. The method of embodiment 9, further comprising mixing the filler with the borate-oleate copolymer for a duration in a range from 1 hour to 2 hours.
Embodiment 19. The method of embodiment 9, further comprising cooling the first colloid to 20° C.
Embodiment 20. The method of embodiment 9, further comprising cooling the silicone gel elastomer to 20° C.
Embodiment 21. The method of embodiment 9, further comprising applying a shear stress or tensile stress to the silicone gel elastomer.
Embodiment 22. A silicone gel elastomer produced by the method of any one of embodiments 9 to 21.
Embodiment 23. A fiber-reinforced composite, the fiber-reinforced composite comprising: a plurality of fibers; a polymer matrix; and a silicone gel elastomer comprising: a copolymer formed from reactions of compounds comprising: hydroxy silicone oil, boric acid, benzoyl peroxide, and oleic acid; a filler; and sulfur.
Embodiment 24. The fiber-reinforced composite of embodiment 23, wherein the plurality of fibers comprises carbon fibers.
Embodiment 25. The fiber-reinforced composite of embodiment 23, wherein the plurality of fibers comprises glass fiber, aramid, or natural fibers.
Embodiment 26. The fiber-reinforced composite of embodiment 23, wherein the polymer matrix comprises an epoxy.
Embodiment 27. The fiber-reinforced composite of embodiment 23, wherein the polymer matrix comprises a thermoset polymer.
Embodiment 28. The fiber-reinforced composite of embodiment 23, wherein the polymer matrix comprises a thermoplastic polymer.
Embodiment 29. The fiber-reinforced composite of embodiment 23, wherein the plurality of fibers is present in a plurality of layers separated by the polymer matrix.
Embodiment 30. The fiber-reinforced composite of embodiment 23, wherein at least a portion of each fiber of the plurality of fibers is coated with the silicone gel elastomer.
Embodiment 31. The fiber-reinforced composite of embodiment 23, wherein the fiber-reinforced composite is characterized by a density in a range from 1.3 to 1.4 g/cm3.
Embodiment 32. The fiber-reinforced composite of embodiment 23, wherein the fiber-reinforced composite is characterized by a specific impact strength in a range from 200 to 210 J m/kg.
Embodiment 33. The fiber-reinforced composite of embodiment 23, wherein a mass fraction of the silicone gel elastomer to the plurality of fibers is in a range from 0.10 to 0.30.
Embodiment 34. The fiber-reinforced composite of embodiment 23, wherein a mass fraction of the silicone gel elastomer to the polymer matrix is in a range from 1.1 to 1.5.
Embodiment 35. The fiber-reinforced composite of embodiment 23, wherein a mass fraction of the polymer matrix to the plurality of fibers is in a range from 0.10 to 0.30.
Embodiment 36. The fiber-reinforced composite of embodiment 23, wherein the fiber-reinforced composite is: 10% to 20% by mass of the silicone gel elastomer; 10% to 20% by mass of the polymer matrix; and 60% to 80% by mass of the plurality of fibers.
Embodiment 37. A method of preparing a composite, the method comprising: mixing a silicone gel elastomer with a solvent to form a solution, wherein the silicone gel elastomer comprises: a copolymer formed from reactions of compounds comprising: hydroxy silicone oil, boric acid, benzoyl peroxide, and oleic acid, a filler, and sulfur; and applying the solution to a plurality of fibers to form a plurality of coated fibers.
Embodiment 38. The method of embodiment 37, further comprising: contacting the plurality of coated fibers with a polymer matrix.
Embodiment 39. The method of embodiment 38, wherein the polymer matrix is an epoxy resin.
Embodiment 40. The method of embodiment 39, wherein the epoxy resin is formed with a mass ratio of monomer to hardener in a range from 3:1 to 4:1.
Embodiment 41. The method of any one of embodiments 38 to 40, further comprising compression molding the plurality of coated fibers and the polymer matrix after contacting.
Embodiment 42. The method of any one of embodiments 38 to 41, wherein the plurality of coated fibers is a first layer of coated fibers, the method further comprising contacting the polymer matrix with a second layer of coated fibers.
Embodiment 43. The method of any one of embodiments 37 to 42, wherein an amount of the solution applied is 0.03 to 0.05 mL of solution per 1 cm2 area of the plurality of fibers.
Embodiment 44. The method of any one of embodiments 37 to 43, wherein a mass ratio of the solvent to the silicone gel elastomer is in a range from 4:1 to 10:1.
Embodiment 45. The method of any one of embodiments 37 to 44, wherein the solvent is an organic solvent.
Embodiment 46. The method of embodiment 45, wherein the solvent is xylene or acetone.
Embodiment 47. The method of any one of embodiments 37 to 46, further comprising heating the solution before applying the solution.
Embodiment 48. The method of any one of embodiments 37 to 47, further comprising heating the plurality of coated fibers.
Embodiment 49. A fiber-reinforced composite produced by the method of any one of embodiments 37 to 48.

What is claimed is:

1. A silicone gel elastomer, the silicone gel elastomer comprising:
a copolymer formed from reactions of compounds comprising:
hydroxy silicone oil,
boric acid,
benzoyl peroxide, and
oleic acid;
a filler; and
sulfur.

2. The silicone gel elastomer of claim 1, further comprising a vulcanization accelerator.

3. The silicone gel elastomer of claim 2, wherein:
a sum of the masses of hydroxy silicone oil, boric acid, benzoyl peroxide, oleic acid, white carbon black, sulfur, and the vulcanization accelerator is a total mass;
the hydroxy silicone oil is in a range from 74% to 86% of the total mass;
the boric acid is in a range from 3% to 6% of the total mass;
the filler is in a range from 10% to 16% of the total mass;
the oleic acid is in a range from 0.3% to 1.5% of the total mass;
the benzoyl peroxide is in a range from 0.1% to 0.5% of the total mass; and
the sulfur is in a range from 0.5% to 1.5% of the total mass.

4. The silicone gel elastomer of claim 1, wherein the filler is white carbon black.

5. The silicone gel elastomer of claim 1, wherein the silicone gel elastomer is characterized by the storage modulus increasing 4 orders of magnitude when an external shear frequency increases from 0.001 Hz to 100 Hz.

6. The silicone gel elastomer of claim 1, wherein the filler is characterized by a median particle size in a range from 50 to 800 nm.

7. The silicone gel elastomer of claim 1, wherein the silicone gel elastomer is characterized by the storage modulus and the loss modulus decreasing by less than 1 order of magnitude when the temperature increases from 30 to 80° C. when an external shear frequency from 0.01 Hz to 100 Hz is applied.

8. The silicone gel elastomer of claim 1, wherein the silicone gel elastomer is characterized by a storage modulus curve with a varying applied frequency that is within 1% of a storage modulus curve with a previous varying applied frequency.

9. A method of preparing a silicone gel elastomer, the method comprising:
reacting hydroxy silicone oil with boric acid to form a borate ester compound;
mixing the borate ester compound with benzoyl peroxide to form a cross-linked mixture;
adding oleic acid to the cross-linked mixture to form a borate-oleate copolymer;
adding a filler to the borate-oleate copolymer to form a first colloid;
adding sulfur to the first colloid to form a second colloid; and
heating the second colloid to form the silicone gel elastomer.

10. The method of claim 9, wherein:
the silicone gel elastomer is characterized by a total mass; or
the hydroxy silicone oil is in a range from 74% to 86% of the total mass; or
the boric acid is in a range from 3% to 6% of the total mass; or
the filler is in a range from 10% to 16% of the total mass; or
the oleic acid is in a range from 0.3% to 1.5% of the total mass; or
the benzoyl peroxide is in a range from 0.1% to 0.5% of the total mass; or
the sulfur is in a range from 0.5% to 1.5% of the total mass.

11. A fiber-reinforced composite, the fiber-reinforced composite comprising:
a plurality of fibers;
a polymer matrix; and
a silicone gel elastomer comprising:
a copolymer formed from reactions of compounds comprising:
hydroxy silicone oil,
boric acid,
benzoyl peroxide, and
oleic acid;
a filler; and
sulfur.

12. The fiber-reinforced composite of claim 11, wherein the plurality of fibers comprises carbon fibers.

13. The fiber-reinforced composite of claim 11, wherein the polymer matrix comprises an epoxy.

14. The fiber-reinforced composite of claim 11, wherein the plurality of fibers is present in a plurality of layers separated by the polymer matrix.

15. The fiber-reinforced composite of claim 11, wherein at least a portion of each fiber of the plurality of fibers is coated with the silicone gel elastomer.

16. The fiber-reinforced composite of claim 11, wherein the fiber-reinforced composite is characterized by a density in a range from 1.3 to 1.4 g/cm³.

17. The fiber-reinforced composite of claim 11, wherein the fiber-reinforced composite is characterized by a specific impact strength in a range from 200 to 210 J·m/kg.

18. The fiber-reinforced composite of claim 11, wherein a mass fraction of the silicone gel elastomer to the plurality of fibers is in a range from 0.10 to 0.30.

19. The fiber-reinforced composite of claim 11, wherein a mass fraction of the silicone gel elastomer to the polymer matrix is in a range from 1.1 to 1.5.

20. The fiber-reinforced composite of claim 11, wherein a mass fraction of the polymer matrix to the plurality of fibers is in a range from 0.10 to 0.30.

21. The fiber-reinforced composite of claim 11, wherein the fiber-reinforced composite is:
10% to 20% by mass of the silicone gel elastomer;
10% to 20% by mass of the polymer matrix; and
60% to 80% by mass of the plurality of fibers.
